(19) United States
(12) Patent Application Publication
(10) Pub. No.: US 2026/0288266 A1
(43) Pub. Date: Sep. 24, 2026

(54) SYSTEMS AND METHODS FOR GENERATING SYNTHESIZED COORDINATE DATA BASED ON HANDHELD DEVICE MOTION

(71) Applicant: Meta Platforms Technologies, LLC, Menlo Park, CA (US)

(72) Inventors: Sheng Shen, Shoreline, WA (US); Paul Austin Buckley, Spokane, WA (US); Qingyi Dong, Santa Clara, CA (US); Daniel Santiago Ginez, Shoreline, WA (US)

(21) Appl. No.: 19/573,900

(22) Filed: Mar. 20, 2026

Related U.S. Application Data
(60) Provisional application No. 63/775,887, filed on Mar. 21, 2025.

(51) Int. Cl. G06F 3/038; A63F 13/24; G05G 9/047

(52) U.S. Cl. CPC G06F 3/038; A63F 13/24; G05G 9/047; G05G 2009/0474

(57) ABSTRACT

A method for generating synthesized coordinate data is provided. The method comprises receiving first motion data from an input actuator of the handheld device, the first motion data representing a movement of the input actuator and corresponding to a first data format, determining whether an operating mode switching condition is satisfied with respect to the input actuator, activating, at least in part based on satisfaction of the operating mode switching condition, operation of the handheld device in a second mode, receiving second motion data from a sensor of the handheld device, the second motion data representing a movement of the handheld device and corresponding to a second data format, generating, when the handheld device is operating in the second mode, synthesized coordinate data from the second motion data, the synthesized coordinate data corresponding to the first data format, and transmitting the synthesized coordinate data.

### CROSS REFERENCE TO RELATED APPLICATION

This application claims the benefit of a U.S. Provisional Application having U.S. Provisional Application No. 63/775,887, filed Mar. 21, 2025, the disclosure of which is incorporated by reference herein, in its entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of a computer-implemented method for generating synthesized coordinate data, according to some aspects of this disclosure.

FIG. 2 is an illustration of an example artificial-reality system according to some embodiments of this disclosure.

FIG. 3 is an illustration of an example artificial-reality system with a handheld device according to some embodiments of this disclosure.

FIG. 4A is an illustration of example user interactions within an artificial-reality system according to some embodiments of this disclosure.

FIG. 4B is an illustration of example user interactions within an artificial-reality system according to some embodiments of this disclosure.

FIG. 5A is an illustration of example user interactions within an artificial-reality system according to some embodiments of this disclosure.

FIG. 5B is an illustration of example user interactions within an artificial-reality system according to some embodiments of this disclosure.

FIG. 6 is an illustration of an example wrist-wearable device of an artificial-reality system according to some embodiments of this disclosure.

FIG. 7 is an illustration of an example wearable artificial-reality system according to some embodiments of this disclosure.

FIG. 8 is an illustration of an example augmented-reality system according to some embodiments of this disclosure.

FIG. 9A is an illustration of an example virtual-reality system according to some embodiments of this disclosure.

FIG. 9B is an illustration of another perspective of the virtual-reality systems shown in FIG. 9A.

FIG. 10 is a block diagram showing system components of example artificial- and virtual-reality systems.

FIG. 11A is an illustration of an example intermediary processing device according to embodiments of this disclosure.

FIG. 11B is a perspective view of the intermediary processing device shown in FIG. 11A.

FIG. 12 is a block diagram showing example components of the intermediary processing device illustrated in FIGS. 11A and 11B.

FIG. 13 illustrates an operating environment in which an example handheld device can implement various techniques of a corrective input data generation system of the present disclosure, according to some aspects described and illustrated herein.

FIG. 14 illustrates the detection of an operating mode switching condition via implementation of the corrective input data generation system of the present disclosure, according to some aspects described and illustrated herein.

FIG. 15 describes activation of the example handheld device in a second mode by the corrective input data generation system of the present disclosure, according to some aspects described and illustrated herein.

FIG. 16 illustrates the generating of the synthesized coordinate data by the corrective input data generation system of the present disclosure, according to some aspects described and illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Handheld controllers used with computing systems, including gaming, augmented-reality, and virtual-reality systems, commonly include analog joysticks (analog sticks) that generate directional input based on physical movement by a user. In some examples, movement of an analog stick is converted into coordinate data for controlling movement of a character, navigating a user interface, or otherwise interacting with digital content. However, analog sticks may deteriorate over time due to regular use, age, mishandling, or other factors. Such deterioration can result in reduced sensitivity, unintended drift away from a neutral position, or intermittent directional response, all of which significantly degrade the reliability of directional control.

In some examples, attempts to address such malfunctions may include recalibration techniques or hardware repair or replacement, which may increase a neutral zone or otherwise reduce a usable working range of the analog stick, thereby providing limited relief. Hardware repair or replacement may restore functionality, but such approaches may be costly, time-consuming, or unavailable when replacement parts or replacement controllers are not readily accessible. As a result, a user may be unable to use directional-control functionality of his joystick. As such, there is a need for improved techniques that preserve directional-input functionality of a handheld controller even when an analog stick exhibits drift, failure, or otherwise degrades.

The techniques disclosed herein address these issues by enabling a handheld controller to transition from operating in a first mode, in which coordinate data is obtained from an analog joystick of the controller, to a second mode, in which motion information from an inertial measurement unit of the controller is used. Specifically, data from the inertial measurement unit is analyzed and processed to generate synthesized coordinate data that conforms to or is in the data format specific to the analog stick. In this way, motion information obtained from the inertial measurement unit may replace or supplement data obtained from the analog joystick, thereby preserving directional control functionality (e.g., due to analog joystick operational degradation), while remaining compatible with downstream systems that are configured to analyze data in the data format specific to the analog joystick.

Features from any of the embodiments described herein may be used in combination with one another in accordance with the general principles described herein. These and other embodiments, features, and advantages will be more fully understood upon reading the following detailed description in conjunction with the accompanying drawings and claims.

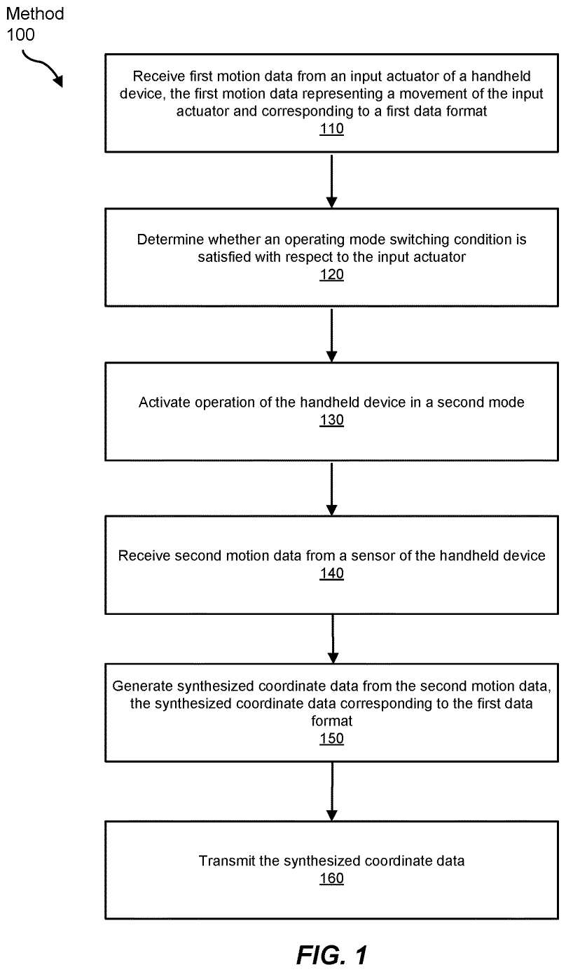

FIG. 1 is a flow diagram of a computer-implemented method 100 for generating synthesized coordinate data. At step 110, a processor of a handheld device (e.g., a gaming controller) can receive first motion data from an input actuator of the handheld device. In some aspects, the input actuator can be an analog joystick configured to provide directional control input, and the first motion data can represent physical movement of the analog joystick in a first data format associated with the analog joystick. For example, the first data format can correspond to coordinate-based input data in which a first value corresponds to movement along an x-axis and a second value corresponds to movement along a y-axis, such that the handheld device can receive directional input in a form suitable for communication to an external computing device (with which the handheld device is communicatively coupled) for downstream processing.

In aspects, a user can move the analog joystick leftward, rightward, forward, backward, diagonally, or in another direction. In response, a contact sensor positioned on the analog joystick can generate electrical signals corresponding to the joystick movement, and route these signals to the handheld device's processor for additional analysis and processing. In aspects, these electrical signals may be routed, automatically and without user intervention, to the external computing device, which may be operating in conjunction with the handheld device to process the signals. In aspects, the handheld device can combine a first value associated with the x-axis and a second value associated with the y-axis into an x-y coordinate pair representative of an instantaneous joystick position and the handheld device can communicate that coordinate data to the external computing device for use in controlling a character, navigating a user interface, or otherwise interacting with digital content. In other aspects, the handheld device may simply transfer these signals to the external computing device, which may generate the coordinate pair representative of the joystick position.

At step 120, the external computing device operating in conjunction with the handheld device can determine whether an operating mode switching condition is satisfied with respect to the input actuator of the handheld device. In some aspects, this determination can be performed by the handheld device independently. The operating mode switching condition can be used to determine whether continued reliance on the input actuator for directional control is desirable. In aspects, whether the operating mode switching condition has been satisfied can be determined, automatically, based on an operating condition of the input actuator. In other aspects, such a condition may be determined to have been satisfied upon a user selection that results in the initiation of the handheld device in a second mode.

For example, the handheld device operating in conjunction with the external computing device can analyze the first motion data received from the analog joystick and determine whether the analog joystick satisfies a degradation parameter. The degradation parameter can correspond to drift, failure, instability, or another unreliable control state, such as a deviation from an expected neutral position, a persistence of unintended non-zero output, or another metric indicative of degraded operation. In some aspects, the operating mode switching condition can additionally or alternatively be satisfied when the external computing device presents a user-selectable option to initiate a second mode and the handheld device, operating in conjunction with the external computing device, receives a user selection of that option.

At step 130, the processor of the handheld device, operating with the external computing device, can activate operation of the handheld device in a second mode at least in part based on satisfaction of the operating mode switching condition. In aspects, activation of the second mode can be distinct from initiation of the second mode, such that satisfaction of the operating mode switching condition can cause the second mode to become available and one or more additional actions can cause the second mode to become actively engaged. In aspects, this activation can be performed by the handheld device or by a corrective input data generation system that includes the handheld device operating in conjunction with the external computing device.

For example, after the operating mode switching condition has been satisfied, the handheld device operating in conjunction with the external computing device can detect user interaction associated with the handheld device and can activate operation in the second mode responsive to that interaction. For instance, the handheld device can determine that the user has contacted the analog joystick and has tilted or moved the handheld device in a particular direction. In some aspects, these actions, performed simultaneously, sequentially, or within a particular time interval, can enable the handheld device operating in conjunction with the external computing device to activate operation of the handheld device in the second mode.

At step 140, the computer can receive second motion data from a sensor of the handheld device while the handheld device is operating in the second mode. For example, the sensor can be an inertial measurement unit that includes one or more accelerometers and one or more gyroscopes configured to detect movement, tilt, orientation, acceleration, rotation, or other motion-related characteristics of the handheld device.

By way of an example, the inertial measurement unit of the handheld device can generate raw acceleration samples along multiple axes, such as acceleration values along x-axis, y-axis, and z-axis directions, and can also generate raw angular-velocity samples corresponding to rotational movement of the handheld device, such as roll-rate data and pitch-rate data. In some aspects, these raw sensor values can be received by the processor of the handheld device as successive samples that represent leftward movement, rightward movement, forward movement, backward movement, or other tilt or motion of the handheld device. Because the inertial measurement unit is part of the handheld device, the handheld device can directly receive this second motion data while remaining in communication with the external computing device.

At step 150, the external computing device, operating in conjunction with the handheld device, can generate synthesized coordinate data from the second motion data. For example, motion information received from the sensor can be processed to derive motion components corresponding to different directions of movement of the handheld device, and those motion components can be transformed into coordinate components that correspond to the coordinate format ordinarily associated with the analog joystick. In this manner, motion information obtained from the handheld device can be converted into replacement or supplemental directional input that remains compatible with the first data format.

For example, the handheld device, operating in conjunction with the external computing device, can derive a first motion component representing left-right tilt motion of the handheld device and a second motion component representing forward-backward tilt motion of the handheld device. The handheld device, optionally in conjunction with processing performed by the external computing device, can determine whether the motion components satisfy one or more threshold values and, responsive to that determination, can apply one or more scaling values to map the motion components into the coordinate space associated with the analog joystick. In some aspects, the handheld device operating in conjunction with the external computing device can threshold, scale, clip, suppress, normalize, or otherwise transform the motion components to generate synthesized coordinate data including an x-coordinate component and a y-coordinate component corresponding to the first data format.

At step 160, the computer can transmit the synthesized coordinate data to a device external to the computer based at least in part on satisfaction of the operating mode switching condition and operation of the handheld device in the second mode. In some aspects, the device that is external to the handheld device could be the external computing device and any additional devices that are communicatively coupled to the external computing device and the handheld device. This transmission can be performed by the handheld device, and the external computing device can receive the synthesized coordinate data for downstream processing. Because the synthesized coordinate data corresponds to the first data format associated with the input actuator, the external computing device can process the synthesized coordinate data as directional input without requiring substantial modification to an input interface that ordinarily expects actuator-derived coordinate data.

In some aspects, the techniques described herein disclosed process can be used in a setting where a person is using a handheld controller with an external computing system, such as an augmented-reality or virtual-reality system. At first, the controller can operate in a normal mode in which a joystick provides the directional input used to control movement in a game or other digital experience. In that arrangement, the controller can receive movement information from the joystick and use that information as the main source of directional control.

In some aspects, the process can then determine whether a switching condition has been met for moving away from joystick-based control. In plain terms, this can mean deciding whether the system should stop relying primarily on the joystick and begin using another source of control input. The figures also indicate that this change can involve a mode initiation stage and a later mode activation stage, which can help the system move into the alternate control approach in an orderly way rather than changing input behavior abruptly.

Once the alternate mode is active, the controller can begin using motion information from a sensor in the handheld device, such as an inertial measurement unit, instead of depending only on the joystick data stream. In some aspects, the controller can receive motion data that reflects how the handheld device itself is being moved or tilted, and the system can process that motion data to create synthesized coordinates. These synthesized coordinates can stand in for the directional coordinates that would otherwise have come from the joystick, allowing the motion of the handheld device to function like joystick input.

This approach can provide several practical benefits. For example, it can help preserve directional control even when the joystick is no longer the preferred source of input, and it can allow the system to continue supplying coordinate-based control data to the external computing device in a form that the external system can still use. In some aspects, this can reduce interruption to the user, support continued gameplay or interaction in an AR or VR environment, and provide a smoother transition from joystick-based control to motion-based control without requiring the overall system to abandon coordinate-style input.

### EXAMPLE EMBODIMENTS

Example 1: A computer-implemented method may include receiving, by the computer of a handheld device operating in a first mode, first motion data from an input actuator of the handheld device, the first motion data representing a movement of the input actuator and corresponding to a first data format; determining, by the computer, whether an operating mode switching condition is satisfied with respect to the input actuator; activating at least in part based on satisfaction of the operating mode switching condition, by the computer, operation of the handheld device in a second mode; receiving, by the computer, second motion data from a sensor of the handheld device, the second motion data representing a movement of the handheld device and corresponding to a second data format; generating when the handheld device is operating in the second mode, by the computer, synthesized coordinate data from the second motion data, the synthesized coordinate data corresponding to the first data format; and transmitting, by the computer, the synthesized coordinate data to a device that is external to the computer based at least in part on the satisfaction of the operating mode switching condition and the operation of the handheld device in the second mode.

Example 2: The computer-implemented method of Example 1, wherein: the handheld device is a gaming controller; the input actuator is an analog joystick; and the sensor is an inertial measurement unit (IMU).

Example 3: The computer-implemented method of any of Examples 1-2, wherein the first motion data includes a plurality of coordinate values, each coordinate value including a first value along an x-axis and a second value along a y-axis.

Example 4: The computer-implemented method of any of Examples 1-3, wherein the determining of whether the operating mode switching condition is satisfied comprises determining whether the input actuator satisfies a degradation parameter.

Example 5: The computer-implemented method of any of Examples 1-4, wherein the determining of whether the operating mode switching condition is satisfied comprises receiving a user selection for initiating the second mode.

Example 6: The computer-implemented method of any of Examples 1-5, wherein the activating of the operation of the handheld device in the second mode comprises: determining by the computer, using a contact sensor positioned on the input actuator, that a user contacted the input actuator; determining by the computer, using the inertial measurement unit (IMU) of the handheld device, a tilt motion of the handheld device; and implementing the activation of the handheld device in the second mode.

Example 7: The computer-implemented method of any of Examples 1-6, wherein the generating of the synthesized coordinate data from the second motion data comprises: applying a plurality of adjustment parameters to a first motion component of the second motion data and a second motion component of the second motion data to generate an x-coordinate component and a y-coordinate component specific to the synthesized coordinate data.

Example 8: The computer-implemented method of any of Examples 1-7, wherein the plurality of adjustment parameters comprise at least one threshold value and at least one scaling value.

Example 9: The computer-implemented method of any of Examples 1-8, wherein the applying of the plurality of adjustment parameters comprises: determining whether the first motion component of the second motion data and the second motion component of the second motion data satisfy the at least one threshold value; and applying, responsive to the determining, the at least one scaling value to each of the first motion component and the second motion component.

Example 10: The computer-implemented method of any of Examples 1-9, wherein: the first motion component represents a first value specific to a tilt motion of the handheld device in one of a left direction or a right direction; and the second motion component represents a second value specific to an additional tilt motion of the handheld device in one of a forward direction or a backward direction.

Example 11: A system comprising: at least one physical processor of a handheld device; physical memory of the handheld device comprising computer-executable instructions that, when executed by the physical processor, cause the physical processor to: receive first motion data from an input actuator of the handheld device, the first motion data representing a movement of the input actuator and corresponding to a first data format; determine whether an operating mode switching condition is satisfied with respect to the input actuator; activate, at least in part based on satisfaction of the operating mode switching condition, operation of the handheld device in a second mode; receive second motion data from a sensor of the handheld device, the second motion data representing a movement of the handheld device and corresponding to a second data format; generate, when the handheld device is operating in the second mode, synthesized coordinate data from the second motion data, the synthesized coordinate data corresponding to the first data format; and transmit the synthesized coordinate data to a device that is external to the at least one physical processor based at least in part on the satisfaction of the operating mode switching condition and the operation of the handheld device in the second mode.

Example 12: The system of Example 11, wherein: the handheld device is a gaming controller; the input actuator is an analog joystick; and the sensor is an inertial measurement unit (IMU).

Example 13: The system of any of Examples 11-12, wherein the first motion data includes a plurality of coordinate values, each coordinate value including a first value along an x-axis and a second value along a y-axis.

Example 14: The system of any of Examples 11-13, wherein the computer-executable instructions that, when executed by the physical processor, cause the physical processor to determine whether the operating mode switching condition is satisfied by determining whether the input actuator satisfies a degradation parameter.

Example 15: The system of any of Examples 11-14, wherein the computer-executable instructions that, when executed by the physical processor, cause the physical processor to determine whether the operating mode switching condition is satisfied by receiving a user selection for initiating the second mode.

Example 16: The system of any of Examples 11-15, wherein the computer-executable instructions that, when executed by the physical processor, cause the physical processor to activate the operation of the handheld device in the second mode by: determining, using a contact sensor positioned on the input actuator, that a user contacted the input actuator; determining, using the inertial measurement unit (IMU) of the handheld device, a tilt motion of the handheld device; and implementing the activation of the handheld device in the second mode.

Example 17: A non-transitory computer-readable medium comprising one or more computer-executable instructions that, when executed by at least one processor of a computing device of a handheld device, cause the computing device to: receive first motion data from an input actuator of the handheld device, the first motion data representing a movement of the input actuator and corresponding to a first data format; determine whether an operating mode switching condition is satisfied with respect to the input actuator; activate, at least in part based on satisfaction of the operating mode switching condition, operation of the handheld device in a second mode; receive second motion data from a sensor of the handheld device, the second motion data representing a movement of the handheld device and corresponding to a second data format; generate, when the handheld device is operating in the second mode, synthesized coordinate data from the second motion data, the synthesized coordinate data corresponding to the first data format; and transmit the synthesized coordinate data to a device that is external to the computer based at least in part on the satisfaction of the operating mode switching condition and the operation of the handheld device in the second mode.

Example 18: The non-transitory computer-readable medium of Example 17, wherein the handheld device is a gaming controller.

Example 19: The non-transitory computer-readable medium of any of Examples 17-18, wherein the first motion data includes a plurality of coordinate values, each coordinate value including a first value along an x-axis and a second value along a y-axis.

Example 20: The non-transitory computer-readable medium of any of Examples 17-19, the input actuator is an analog joystick; and the sensor is an inertial measurement unit (IMU).

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

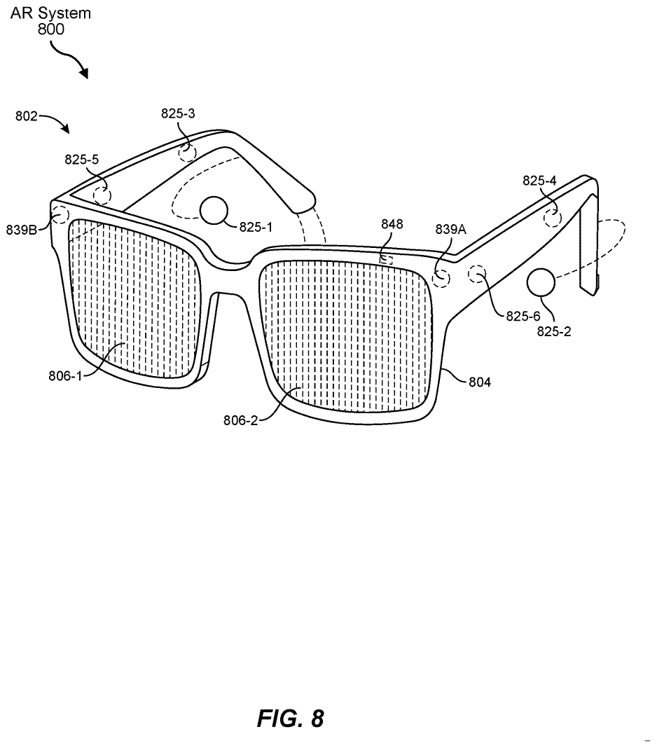

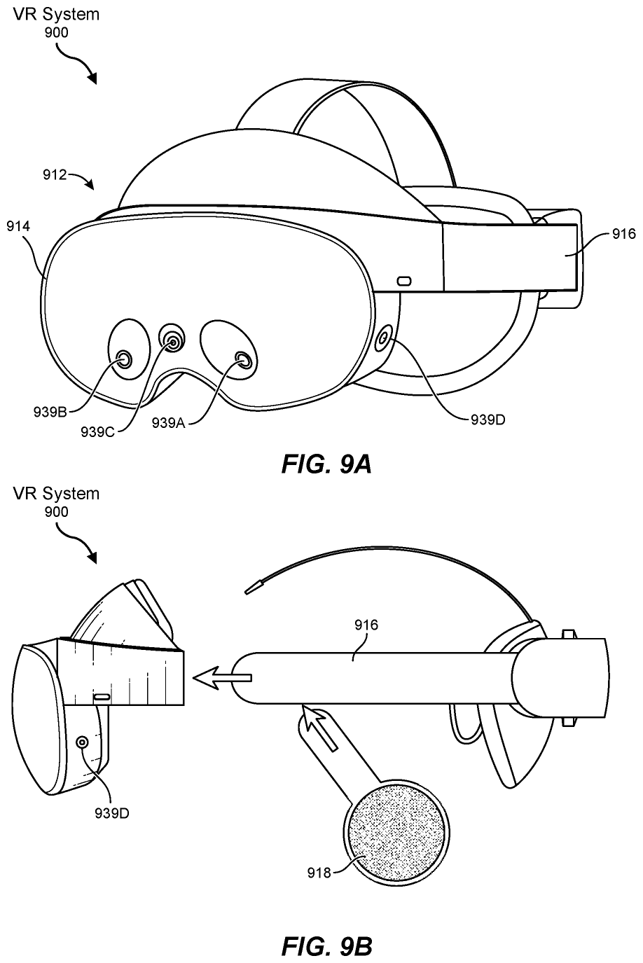

AR systems may be implemented in a variety of different form factors and configurations. Some AR systems may be designed to work without near-eye displays (NEDs). Other AR systems may include a NED that also provides visibility into the real world (such as, e.g., augmented-reality system 800 in FIG. 8) or that visually immerses a user in an artificial reality (such as, e.g., virtual-reality system 900 in FIGS. 9A and 9B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

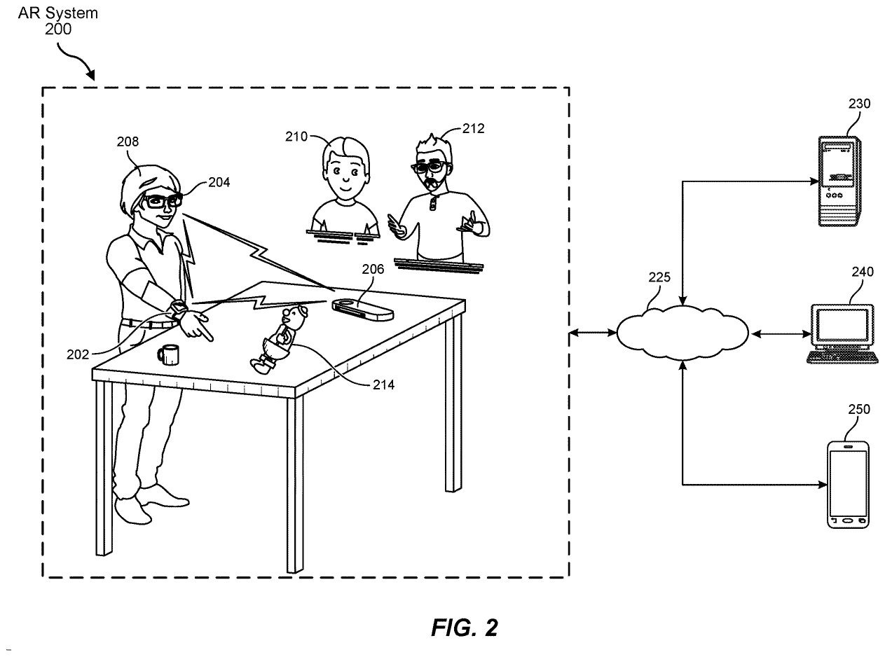

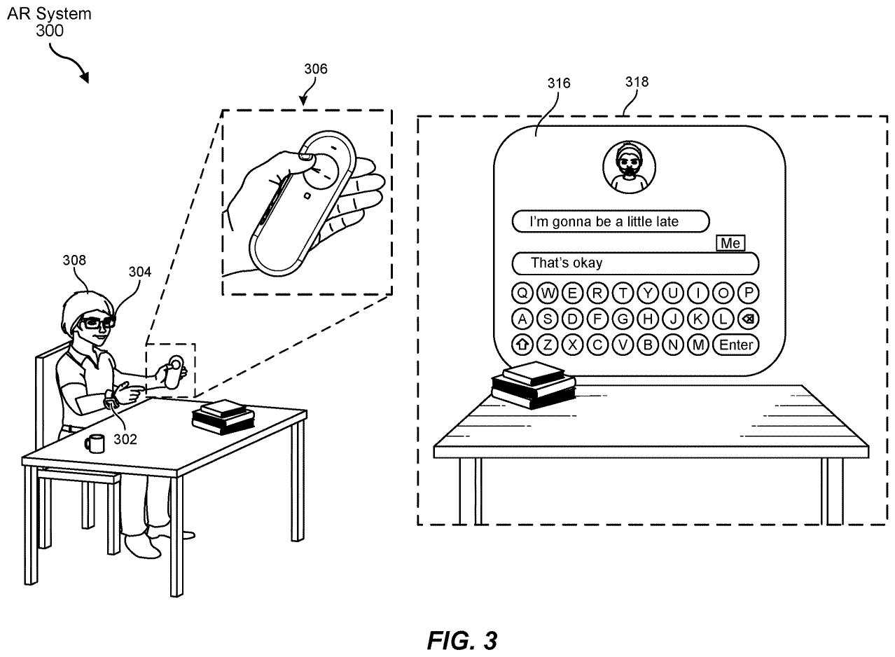

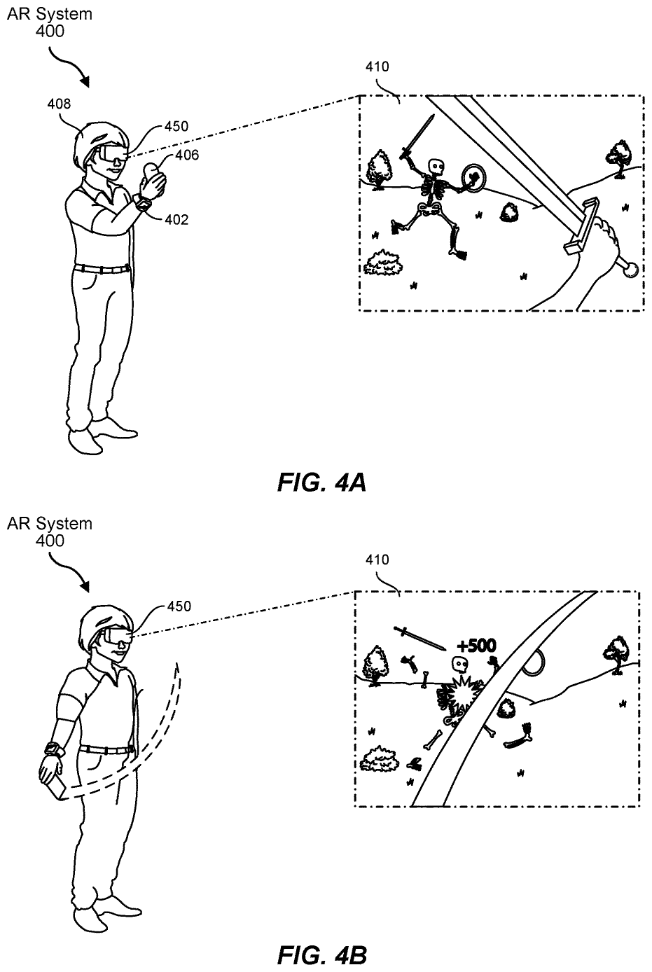

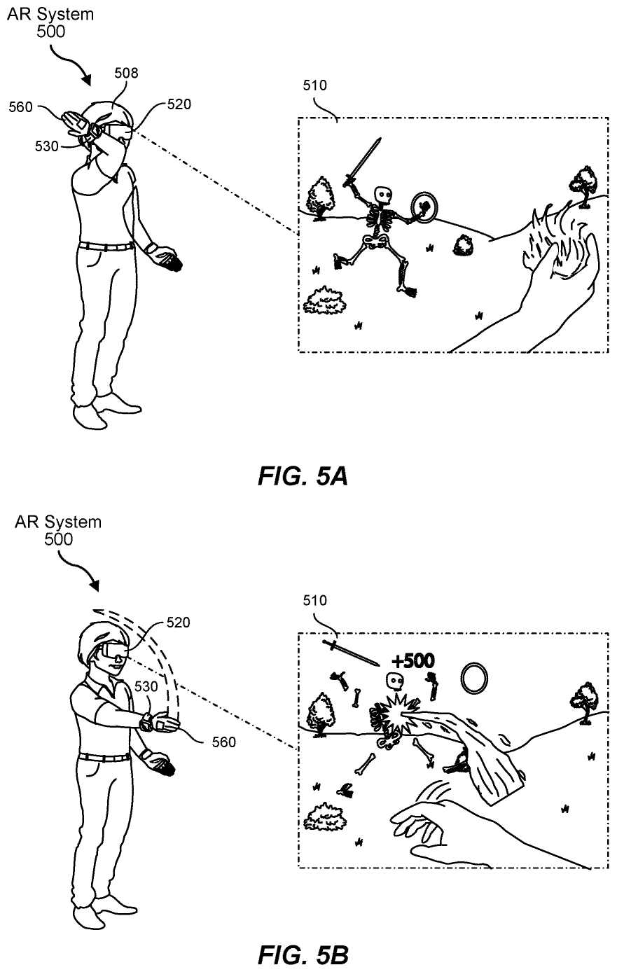

FIGS. 2-5B illustrate example artificial-reality (AR) systems in accordance with some embodiments. FIG. 2 shows a first AR system 200 and first example user interactions using a wrist-wearable device 202, a head-wearable device (e.g., AR system 800), and/or a handheld intermediary processing device (HIPD) 206. FIG. 3 shows a second AR system 300 and second example user interactions using a wrist-wearable device 302, AR glasses 304, and/or an HIPD 306. FIGS. 4A and 4B show a third AR system 400 and third example user 408 interactions using a wrist-wearable device 402, a head-wearable device (e.g., VR headset 450), and/or an HIPD 406. FIGS. 5A and 5B show a fourth AR system 500 and fourth example user 508 interactions using a wrist-wearable device 530, VR headset 520, and/or a haptic device 560 (e.g., wearable gloves).

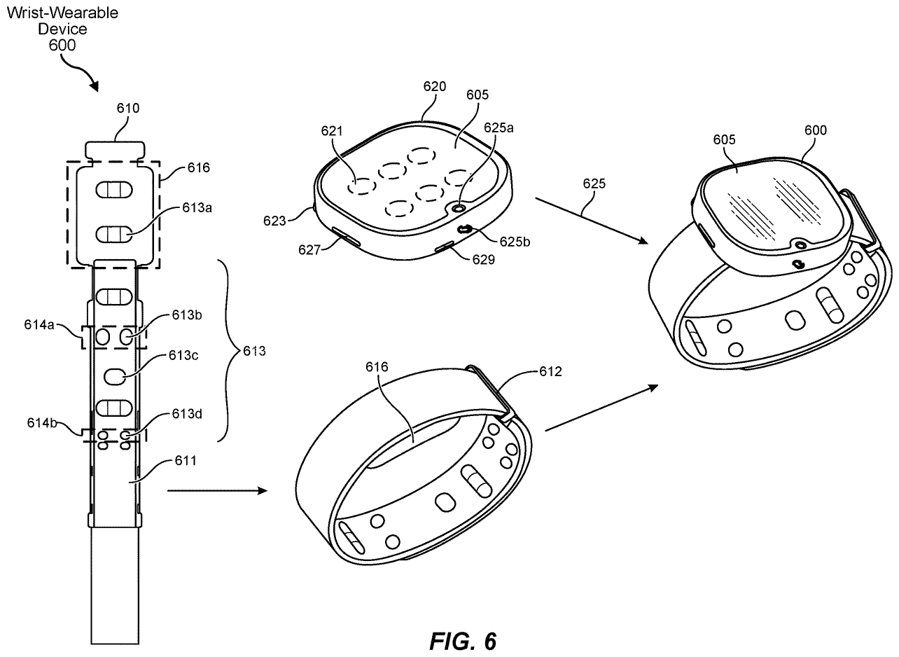

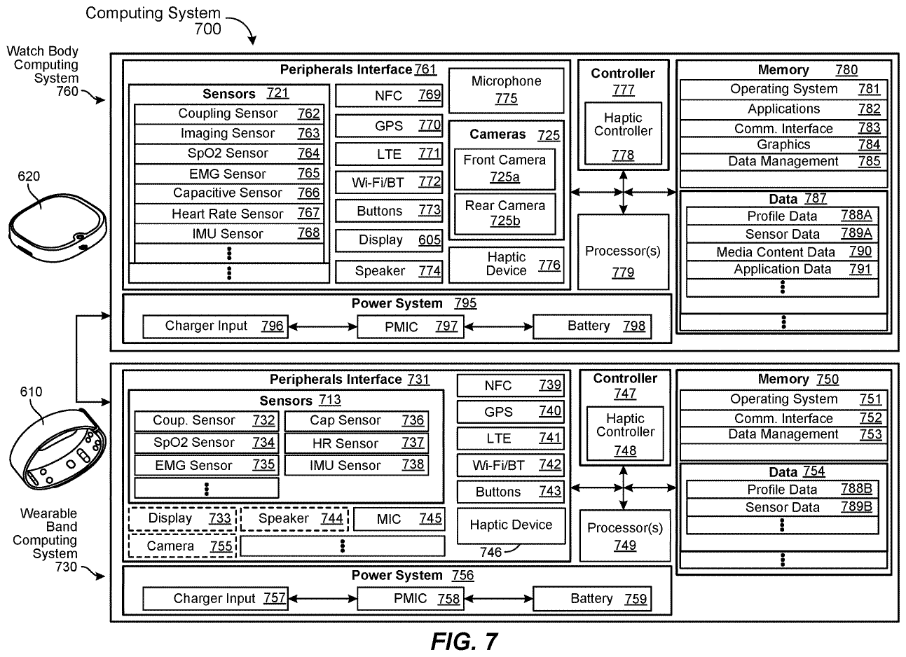

A wrist-wearable device 600, which can be used for wrist-wearable device 202, 302, 402, 530, and one or more of its components, are described below in reference to FIGS. 6 and 7; head-wearable devices, which can respectively be used for AR glasses 204, 304 or VR headset 450, 520, and their one or more components are described below in reference to FIGS. 8-10.

Referring to FIG. 2, wrist-wearable device 202, AR glasses 204, and/or HIPD 206 can communicatively couple via a network 225 (e.g., cellular, near field, Wi-Fi, personal area network, wireless LAN, etc.). Additionally, wrist-wearable device 202, AR glasses 204, and/or HIPD 206 can also communicatively couple with one or more servers 230, computers 240 (e.g., laptops, computers, etc.), mobile devices 250 (e.g., smartphones, tablets, etc.), and/or other electronic devices via network 225 (e.g., cellular, near field, Wi-Fi, personal area network, wireless LAN, etc.).

In FIG. 2, a user 208 is shown wearing wrist-wearable device 202 and AR glasses 204 and having HIPD 206 on their desk. The wrist-wearable device 202, AR glasses 204, and HIPD 206 facilitate user interaction with an AR environment. In particular, as shown by first AR system 200, wrist-wearable device 202, AR glasses 204, and/or HIPD 206 cause presentation of one or more avatars 210, digital representations of contacts 212, and virtual objects 214. As discussed below, user 208 can interact with one or more avatars 210, digital representations of contacts 212, and virtual objects 214 via wrist-wearable device 202, AR glasses 204, and/or HIPD 206.

User 208 can use any of wrist-wearable device 202, AR glasses 204, and/or HIPD 206 to provide user inputs. For example, user 208 can perform one or more hand gestures that are detected by wrist-wearable device 202 (e.g., using one or more EMG sensors and/or IMUs, described below in reference to FIGS. 6 and 7) and/or AR glasses 204 (e.g., using one or more image sensors or cameras, described below in reference to FIGS. 8-10) to provide a user input. Alternatively, or additionally, user 208 can provide a user input via one or more touch surfaces of wrist-wearable device 202, AR glasses 204, HIPD 206, and/or voice commands captured by a microphone of wrist-wearable device 202, AR glasses 204, and/or HIPD 206. In some embodiments, wrist-wearable device 202, AR glasses 204, and/or HIPD 206 include a digital assistant to help user 208 in providing a user input (e.g., completing a sequence of operations, suggesting different operations or commands, providing reminders, confirming a command, etc.). In some embodiments, user 208 can provide a user input via one or more facial gestures and/or facial expressions. For example, cameras of wrist-wearable device 202, AR glasses 204, and/or HIPD 206 can track eyes of user 208 for navigating a user interface.

Wrist-wearable device 202, AR glasses 204, and/or HIPD 206 can operate alone or in conjunction to allow user 208 to interact with the AR environment. In some embodiments, HIPD 206 is configured to operate as a central hub or control center for the wrist-wearable device 202, AR glasses 204, and/or another communicatively coupled device. For example, user 208 can provide an input to interact with the AR environment at any of wrist-wearable device 202, AR glasses 204, and/or HIPD 206, and HIPD 206 can identify one or more back-end and front-end tasks to cause the performance of the requested interaction and distribute instructions to cause the performance of the one or more back-end and front-end tasks at wrist-wearable device 202, AR glasses 204, and/or HIPD 206. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 206 can perform the back-end tasks and provide wrist-wearable device 202 and/or AR glasses 204 operational data corresponding to the performed back-end tasks such that wrist-wearable device 202 and/or AR glasses 204 can perform the front-end tasks. In this way, HIPD 206, which has more computational resources and greater thermal headroom than wrist-wearable device 202 and/or AR glasses 204, performs computationally intensive tasks and reduces the computer resource utilization and/or power usage of wrist-wearable device 202 and/or AR glasses 204.

In the example shown by first AR system 200, HIPD 206 identifies one or more back-end tasks and front-end tasks associated with a user request to initiate an AR video call with one or more other users (represented by avatar 210 and the digital representation of contact 212) and distributes instructions to cause the performance of the one or more back-end tasks and front-end tasks. In particular, HIPD 206 performs back-end tasks for processing and/or rendering image data (and other data) associated with the AR video call and provides operational data associated with the performed back-end tasks to AR glasses 204 such that the AR glasses 204 perform front-end tasks for presenting the AR video call (e.g., presenting avatar 210 and digital representation of contact 212).

In some embodiments, HIPD 206 can operate as a focal or anchor point for causing the presentation of information. This allows user 208 to be generally aware of where information is presented. For example, as shown in first AR system 200, avatar 210 and the digital representation of contact 212 are presented above HIPD 206. In particular, HIPD 206 and AR glasses 204 operate in conjunction to determine a location for presenting avatar 210 and the digital representation of contact 212. In some embodiments, information can be presented a predetermined distance from HIPD 206 (e.g., within 5 meters). For example, as shown in first AR system 200, virtual object 214 is presented on the desk some distance from HIPD 206. Similar to the above example, HIPD 206 and AR glasses 204 can operate in conjunction to determine a location for presenting virtual object 214. Alternatively, in some embodiments, presentation of information is not bound by HIPD 206. More specifically, avatar 210, digital representation of contact 212, and virtual object 214 do not have to be presented within a predetermined distance of HIPD 206.

User inputs provided at wrist-wearable device 202, AR glasses 204, and/or HIPD 206 are coordinated such that the user can use any device to initiate, continue, and/or complete an operation. For example, user 208 can provide a user input to AR glasses 204 to cause AR glasses 204 to present virtual object 214 and, while virtual object 214 is presented by AR glasses 204, user 208 can provide one or more hand gestures via wrist-wearable device 202 to interact and/or manipulate virtual object 214.

FIG. 3 shows a user 308 wearing a wrist-wearable device 302 and AR glasses 304, and holding an HIPD 306. In second AR system 300, the wrist-wearable device 302, AR glasses 304, and/or HIPD 306 are used to receive and/or provide one or more messages to a contact of user 308. In particular, wrist-wearable device 302, AR glasses 304, and/or HIPD 306 detect and coordinate one or more user inputs to initiate a messaging application and prepare a response to a received message via the messaging application.

In some embodiments, user 308 initiates, via a user input, an application on wrist-wearable device 302, AR glasses 304, and/or HIPD 306 that causes the application to initiate on at least one device. For example, in second AR system 300, user 308 performs a hand gesture associated with a command for initiating a messaging application (represented by messaging user interface 316), wrist-wearable device 302 detects the hand gesture and, based on a determination that user 308 is wearing AR glasses 304, causes AR glasses 304 to present a messaging user interface 316 of the messaging application. AR glasses 304 can present messaging user interface 316 to user 308 via its display (e.g., as shown by a field of view 318 of user 308). In some embodiments, the application is initiated and executed on the device (e.g., wrist-wearable device 302, AR glasses 304, and/or HIPD 306) that detects the user input to initiate the application, and the device provides another device operational data to cause the presentation of the messaging application. For example, wrist-wearable device 302 can detect the user input to initiate a messaging application, initiate and run the messaging application, and provide operational data to AR glasses 304 and/or HIPD 306 to cause presentation of the messaging application. Alternatively, the application can be initiated and executed at a device other than the device that detected the user input. For example, wrist-wearable device 302 can detect the hand gesture associated with initiating the messaging application and cause HIPD 306 to run the messaging application and coordinate the presentation of the messaging application.

Further, user 308 can provide a user input provided at wrist-wearable device 302, AR glasses 304, and/or HIPD 306 to continue and/or complete an operation initiated at another device. For example, after initiating the messaging application via wrist-wearable device 302 and while AR glasses 304 present messaging user interface 316, user 308 can provide an input at HIPD 306 to prepare a response (e.g., shown by the swipe gesture performed on HIPD 306). Gestures performed by user 308 on HIPD 306 can be provided and/or displayed on another device. For example, a swipe gesture performed on HIPD 306 is displayed on a virtual keyboard of messaging user interface 316 displayed by AR glasses 304.

In some embodiments, wrist-wearable device 302, AR glasses 304, HIPD 306, and/or any other communicatively coupled device can present one or more notifications to user 308. The notification can be an indication of a new message, an incoming call, an application update, a status update, etc. User 308 can select the notification via wrist-wearable device 302, AR glasses 304, and/or HIPD 306 and can cause presentation of an application or operation associated with the notification on at least one device. For example, user 308 can receive a notification that a message was received at wrist-wearable device 302, AR glasses 304, HIPD 306, and/or any other communicatively coupled device and can then provide a user input at wrist-wearable device 302, AR glasses 304, and/or HIPD 306 to review the notification, and the device detecting the user input can cause an application associated with the notification to be initiated and/or presented at wrist-wearable device 302, AR glasses 304, and/or HIPD 306.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 304 can present to user 308 game application data, and HIPD 306 can be used as a controller to provide inputs to the game. Similarly, user 308 can use wrist-wearable device 302 to initiate a camera of AR glasses 304, and user 308 can use wrist-wearable device 302, AR glasses 304, and/or HIPD 306 to manipulate the image capture (e.g., zoom in or out, apply filters, etc.) and capture image data.

Users may interact with the devices disclosed herein in a variety of ways. For example, as shown in FIGS. 4A and 4B, a user 408 may interact with an AR system 400 by donning a VR headset 450 while holding HIPD 406 and wearing wrist-wearable device 402. In this example, AR system 400 may enable a user to interact with a game 410 by swiping their arm. One or more of VR headset 450, HIPD 406, and wrist-wearable device 402 may detect this gesture and, in response, may display a sword strike in game 410. Similarly, in FIGS. 5A and 5B, a user 508 may interact with an AR system 500 by donning a VR headset 520 while wearing haptic device 560 and wrist-wearable device 530. In this example, AR system 500 may enable a user to interact with a game 510 by swiping their arm. One or more of VR headset 520, haptic device 560, and wrist-wearable device 530 may detect this gesture and, in response, may display a spell being cast in game 410.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs).

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars, (vii) clocks, and (viii) communication interface modules for enabling wired and/or wireless connections between different respective electronic devices (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 6 and 7 illustrate an example wrist-wearable device 600 and an example computer system 700, in accordance with some embodiments. Wrist-wearable device 600 is an instance of wearable device 202 described in FIG. 2 herein, such that the wearable device 202 should be understood to have the features of the wrist-wearable device 600 and vice versa. FIG. 7 illustrates components of the wrist-wearable device 600, which can be used individually or in combination, including combinations that include other electronic devices and/or electronic components.

FIG. 6 shows a wearable band 610 and a watch body 620 (or capsule) being coupled, as discussed below, to form wrist-wearable device 600. Wrist-wearable device 600 can perform various functions and/or operations associated with navigating through user interfaces and selectively opening applications as well as the functions and/or operations described above with reference to FIGS. 2-5B.

As will be described in more detail below, operations executed by wrist-wearable device 600 can include (i) presenting content to a user (e.g., displaying visual content via a display 605), (ii) detecting (e.g., sensing) user input (e.g., sensing a touch on peripheral button 623 and/or at a touch screen of the display 605, a hand gesture detected by sensors (e.g., biopotential sensors)), (iii) sensing biometric data (e.g., neuromuscular signals, heart rate, temperature, sleep, etc.) via one or more sensors 613, messaging (e.g., text, speech, video, etc.); image capture via one or more imaging devices or cameras 625, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 620, independently in wearable band 610, and/or via an electronic communication between watch body 620 and wearable band 610. In some embodiments, functions can be executed on wrist-wearable device 600 while an AR environment is being presented (e.g., via one of AR systems 200 to 500). The wearable devices described herein can also be used with other types of AR environments.

Wearable band 610 can be configured to be worn by a user such that an inner surface of a wearable structure 611 of wearable band 610 is in contact with the user's skin. In this example, when worn by a user, sensors 613 may contact the user's skin. In some examples, one or more of sensors 613 can sense biometric data such as a user's heart rate, a saturated oxygen level, temperature, sweat level, neuromuscular signals, or a combination thereof. One or more of sensors 613 can also sense data about a user's environment including a user's motion, altitude, location, orientation, gait, acceleration, position, or a combination thereof. In some embodiments, one or more of sensors 613 can be configured to track a position and/or motion of wearable band 610. One or more of sensors 613 can include any of the sensors defined above and/or discussed below with respect to FIG. 6.

One or more of sensors 613 can be distributed on an inside and/or an outside surface of wearable band 610. In some embodiments, one or more of sensors 613 are uniformly spaced along wearable band 610. Alternatively, in some embodiments, one or more of sensors 613 are positioned at distinct points along wearable band 610. As shown in FIG. 6, one or more of sensors 613 can be the same or distinct. For example, in some embodiments, one or more of sensors 613 can be shaped as a pill (e.g., sensor 613a), an oval, a circle, a square, an oblong (e.g., sensor 613c) and/or any other shape that maintains contact with the user's skin (e.g., such that neuromuscular signal and/or other biometric data can be accurately measured at the user's skin). In some embodiments, one or more sensors 613 are aligned to form pairs of sensors (e.g., for sensing neuromuscular signals based on differential sensing within each respective sensor). For example, sensor 613b may be aligned with an adjacent sensor to form sensor pair 614a and sensor 613d may be aligned with an adjacent sensor to form sensor pair 614b. In some embodiments, wearable band 610 does not have a sensor pair. Alternatively, in some embodiments, wearable band 610 has a predetermined number of sensor pairs (one pair of sensors, three pairs of sensors, four pairs of sensors, six pairs of sensors, sixteen pairs of sensors, etc.).

Wearable band 610 can include any suitable number of sensors 613. In some embodiments, the number and arrangement of sensors 613 depends on the particular application for which wearable band 610 is used. For instance, wearable band 610 can be configured as an armband, wristband, or chest-band that includes a plurality of sensors 613 with different number of sensors 613, a variety of types of individual sensors with the plurality of sensors 613, and different arrangements for each use case, such as medical use cases as compared to gaming or general day-to-day use cases.

In accordance with some embodiments, wearable band 610 further includes an electrical ground electrode and a shielding electrode. The electrical ground and shielding electrodes, like the sensors 613, can be distributed on the inside surface of the wearable band 610 such that they contact a portion of the user's skin. For example, the electrical ground and shielding electrodes can be at an inside surface of a coupling mechanism 616 or an inside surface of a wearable structure 611. The electrical ground and shielding electrodes can be formed and/or use the same components as sensors 613. In some embodiments, wearable band 610 includes more than one electrical ground electrode and more than one shielding electrode.

Sensors 613 can be formed as part of wearable structure 611 of wearable band 610. In some embodiments, sensors 613 are flush or substantially flush with wearable structure 611 such that they do not extend beyond the surface of wearable structure 611. While flush with wearable structure 611, sensors 613 are still configured to contact the user's skin (e.g., via a skin-contacting surface). Alternatively, in some embodiments, sensors 613 extend beyond wearable structure 611 a predetermined distance (e.g., 0.1-2 mm) to make contact and depress into the user's skin. In some embodiments, sensors 613 are coupled to an actuator (not shown) configured to adjust an extension height (e.g., a distance from the surface of wearable structure 611) of sensors 613 such that sensors 613 make contact and depress into the user's skin. In some embodiments, the actuators adjust the extension height between 0.01 mm-1.2 mm. This may allow a user to customize the positioning of sensors 613 to improve the overall comfort of the wearable band 610 when worn while still allowing sensors 613 to contact the user's skin. In some embodiments, sensors 613 are indistinguishable from wearable structure 611 when worn by the user.

Wearable structure 611 can be formed of an elastic material, elastomers, etc., configured to be stretched and fitted to be worn by the user. In some embodiments, wearable structure 611 is a textile or woven fabric. As described above, sensors 613 can be formed as part of a wearable structure 611. For example, sensors 613 can be molded into the wearable structure 611, be integrated into a woven fabric (e.g., sensors 613 can be sewn into the fabric and mimic the pliability of fabric and can and/or be constructed from a series woven strands of fabric).

Wearable structure 611 can include flexible electronic connectors that interconnect sensors 613, the electronic circuitry, and/or other electronic components (described below in reference to FIG. 7) that are enclosed in wearable band 610. In some embodiments, the flexible electronic connectors are configured to interconnect sensors 613, the electronic circuitry, and/or other electronic components of wearable band 610 with respective sensors and/or other electronic components of another electronic device (e.g., watch body 620). The flexible electronic connectors are configured to move with wearable structure 611 such that the user adjustment to wearable structure 611 (e.g., resizing, pulling, folding, etc.) does not stress or strain the electrical coupling of components of wearable band 610.

As described above, wearable band 610 is configured to be worn by a user. In particular, wearable band 610 can be shaped or otherwise manipulated to be worn by a user. For example, wearable band 610 can be shaped to have a substantially circular shape such that it can be configured to be worn on the user's lower arm or wrist. Alternatively, wearable band 610 can be shaped to be worn on another body part of the user, such as the user's upper arm (e.g., around a bicep), forearm, chest, legs, etc. Wearable band 610 can include a retaining mechanism 612 (e.g., a buckle, a hook and loop fastener, etc.) for securing wearable band 610 to the user's wrist or other body part. While wearable band 610 is worn by the user, sensors 613 sense data (referred to as sensor data) from the user's skin. In some examples, sensors 613 of wearable band 610 obtain (e.g., sense and record) neuromuscular signals.

The sensed data (e.g., sensed neuromuscular signals) can be used to detect and/or determine the user's intention to perform certain motor actions. In some examples, sensors 613 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 605 of wrist-wearable device 600 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 613 can be used to provide a user with an enhanced interaction with a physical object (e.g., devices communicatively coupled with wearable band 610) and/or a virtual object in an artificial-reality application generated by an artificial-reality system (e.g., user interface objects presented on the display 605, or another computing device (e.g., a smartphone)).

In some embodiments, wearable band 610 includes one or more haptic devices 746 (e.g., a vibratory haptic actuator) that are configured to provide haptic feedback (e.g., a cutaneous and/or kinesthetic sensation, etc.) to the user's skin. Sensors 613 and/or haptic devices 746 (shown in FIG. 7) can be configured to operate in conjunction with multiple applications including, without limitation, health monitoring, social media, games, and artificial reality (e.g., the applications associated with artificial reality).

Wearable band 610 can also include coupling mechanism 616 for detachably coupling a capsule (e.g., a computing unit) or watch body 620 (via a coupling surface of the watch body 620) to wearable band 610. For example, a cradle or a shape of coupling mechanism 616 can correspond to the shape of watch body 620 of wrist-wearable device 600. In particular, coupling mechanism 616 can be configured to receive a coupling surface proximate to the bottom side of watch body 620 (e.g., a side opposite to a front side of watch body 620 where display 605 is located), such that a user can push watch body 620 downward into coupling mechanism 616 to attach watch body 620 to coupling mechanism 616. In some embodiments, coupling mechanism 616 can be configured to receive a top side of the watch body 620 (e.g., a side proximate to the front side of watch body 620 where display 605 is located) that is pushed upward into the cradle, as opposed to being pushed downward into coupling mechanism 616. In some embodiments, coupling mechanism 616 is an integrated component of wearable band 610 such that wearable band 610 and coupling mechanism 616 are a single unitary structure. In some embodiments, coupling mechanism 616 is a type of frame or shell that allows watch body 620 coupling surface to be retained within or on wearable band 610 coupling mechanism 616 (e.g., a cradle, a tracker band, a support base, a clasp, etc.).

Coupling mechanism 616 can allow for watch body 620 to be detachably coupled to the wearable band 610 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 620 to wearable band 610 and to decouple the watch body 620 from the wearable band 610. For example, a user can twist, slide, turn, push, pull, or rotate watch body 620 relative to wearable band 610, or a combination thereof, to attach watch body 620 to wearable band 610 and to detach watch body 620 from wearable band 610. Alternatively, as discussed below, in some embodiments, the watch body 620 can be decoupled from the wearable band 610 by actuation of a release mechanism 629.

Wearable band 610 can be coupled with watch body 620 to increase the functionality of wearable band 610 (e.g., converting wearable band 610 into wrist-wearable device 600, adding an additional computing unit and/or battery to increase computational resources and/or a battery life of wearable band 610, adding additional sensors to improve sensed data, etc.). As described above, wearable band 610 and coupling mechanism 616 are configured to operate independently (e.g., execute functions independently) from watch body 620. For example, coupling mechanism 616 can include one or more sensors 613 that contact a user's skin when wearable band 610 is worn by the user, with or without watch body 620 and can provide sensor data for determining control commands.

A user can detach watch body 620 from wearable band 610 to reduce the encumbrance of wrist-wearable device 600 to the user. For embodiments in which watch body 620 is removable, watch body 620 can be referred to as a removable structure, such that in these embodiments wrist-wearable device 600 includes a wearable portion (e.g., wearable band 610) and a removable structure (e.g., watch body 620).

Turning to watch body 620, in some examples watch body 620 can have a substantially rectangular or circular shape. Watch body 620 is configured to be worn by the user on their wrist or on another body part. More specifically, watch body 620 is sized to be easily carried by the user, attached on a portion of the user's clothing, and/or coupled to wearable band 610 (forming the wrist-wearable device 600). As described above, watch body 620 can have a shape corresponding to coupling mechanism 616 of wearable band 610. In some embodiments, watch body 620 includes a single release mechanism 629 or multiple release mechanisms (e.g., two release mechanisms 629 positioned on opposing sides of watch body 620, such as spring-loaded buttons) for decoupling watch body 620 from wearable band 610. Release mechanism 629 can include, without limitation, a button, a knob, a plunger, a handle, a lever, a fastener, a clasp, a dial, a latch, or a combination thereof.

A user can actuate release mechanism 629 by pushing, turning, lifting, depressing, shifting, or performing other actions on release mechanism 629. Actuation of release mechanism 629 can release (e.g., decouple) watch body 620 from coupling mechanism 616 of wearable band 610, allowing the user to use watch body 620 independently from wearable band 610 and vice versa. For example, decoupling watch body 620 from wearable band 610 can allow a user to capture images using rear-facing camera 625b. Although release mechanism 629 is shown positioned at a corner of watch body 620, release mechanism 629 can be positioned anywhere on watch body 620 that is convenient for the user to actuate. In addition, in some embodiments, wearable band 610 can also include a respective release mechanism for decoupling watch body 620 from coupling mechanism 616. In some embodiments, release mechanism 629 is optional and watch body 620 can be decoupled from coupling mechanism 616 as described above (e.g., via twisting, rotating, etc.).

Watch body 620 can include one or more peripheral buttons 623 and 627 for performing various operations at watch body 620. For example, peripheral buttons 623 and 627 can be used to turn on or wake (e.g., transition from a sleep state to an active state) display 605, unlock watch body 620, increase or decrease a volume, increase or decrease a brightness, interact with one or more applications, interact with one or more user interfaces, etc. Additionally or alternatively, in some embodiments, display 605 operates as a touch screen and allows the user to provide one or more inputs for interacting with watch body 620.

In some embodiments, watch body 620 includes one or more sensors 621. Sensors 621 of watch body 620 can be the same or distinct from sensors 613 of wearable band 610. Sensors 621 of watch body 620 can be distributed on an inside and/or an outside surface of watch body 620. In some embodiments, sensors 621 are configured to contact a user's skin when watch body 620 is worn by the user. For example, sensors 621 can be placed on the bottom side of watch body 620 and coupling mechanism 616 can be a cradle with an opening that allows the bottom side of watch body 620 to directly contact the user's skin. Alternatively, in some embodiments, watch body 620 does not include sensors that are configured to contact the user's skin (e.g., including sensors internal and/or external to the watch body 620 that are configured to sense data of watch body 620 and the surrounding environment). In some embodiments, sensors 621 are configured to track a position and/or motion of watch body 620.

Watch body 620 and wearable band 610 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 620 and wearable band 610 can share data sensed by sensors 613 and 621, as well as application and device specific information (e.g., active and/or available applications, output devices (e.g., displays, speakers, etc.), input devices (e.g., touch screens, microphones, imaging sensors, etc.).

In some embodiments, watch body 620 can include, without limitation, a front-facing camera 625a and/or a rear-facing camera 625b, sensors 621 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 763), a touch sensor, a sweat sensor, etc.). In some embodiments, watch body 620 can include one or more haptic devices 776 (e.g., a vibratory haptic actuator) that is configured to provide haptic feedback (e.g., a cutaneous and/or kinesthetic sensation, etc.) to the user. Sensors 721 and/or haptic device 776 can also be configured to operate in conjunction with multiple applications including, without limitation, health monitoring applications, social media applications, game applications, and artificial reality applications (e.g., the applications associated with artificial reality).

As described above, watch body 620 and wearable band 610, when coupled, can form wrist-wearable device 600. When coupled, watch body 620 and wearable band 610 may operate as a single device to execute functions (operations, detections, communications, etc.) described herein. In some embodiments, each device may be provided with particular instructions for performing the one or more operations of wrist-wearable device 600. For example, in accordance with a determination that watch body 620 does not include neuromuscular signal sensors, wearable band 610 can include alternative instructions for performing associated instructions (e.g., providing sensed neuromuscular signal data to watch body 620 via a different electronic device). Operations of wrist-wearable device 600 can be performed by watch body 620 alone or in conjunction with wearable band 610 (e.g., via respective processors and/or hardware components) and vice versa. In some embodiments, operations of wrist-wearable device 600, watch body 620, and/or wearable band 610 can be performed in conjunction with one or more processors and/or hardware components.

As described below with reference to the block diagram of FIG. 7, wearable band 610 and/or watch body 620 can each include independent resources required to independently execute functions. For example, wearable band 610 and/or watch body 620 can each include a power source (e.g., a battery), a memory, data storage, a processor (e.g., a central processing unit (CPU)), communications, a light source, and/or input/output devices.

FIG. 7 shows block diagrams of a computing system 730 corresponding to wearable band 610 and a computing system 760 corresponding to watch body 620 according to some embodiments. Computing system 700 of wrist-wearable device 600 may include a combination of components of wearable band computing system 730 and watch body computing system 760, in accordance with some embodiments.

Watch body 620 and/or wearable band 610 can include one or more components shown in watch body computing system 760. In some embodiments, a single integrated circuit may include all or a substantial portion of the components of watch body computing system 760 included in a single integrated circuit. Alternatively, in some embodiments, components of the watch body computing system 760 may be included in a plurality of integrated circuits that are communicatively coupled. In some embodiments, watch body computing system 760 may be configured to couple (e.g., via a wired or wireless connection) with wearable band computing system 730, which may allow the computing systems to share components, distribute tasks, and/or perform other operations described herein (individually or as a single device).

Watch body computing system 760 can include one or more processors 779, a controller 777, a peripherals interface 761, a power system 795, and memory (e.g., a memory 780).

Power system 795 can include a charger input 796, a power-management integrated circuit (PMIC) 797, and a battery 798. In some embodiments, a watch body 620 and a wearable band 610 can have respective batteries (e.g., battery 798 and 759) and can share power with each other. Watch body 620 and wearable band 610 can receive a charge using a variety of techniques. In some embodiments, watch body 620 and wearable band 610 can use a wired charging assembly (e.g., power cords) to receive the charge. Alternatively, or in addition, watch body 620 and/or wearable band 610 can be configured for wireless charging. For example, a portable charging device can be designed to mate with a portion of watch body 620 and/or wearable band 610 and wirelessly deliver usable power to battery 798 of watch body 620 and/or battery 759 of wearable band 610. Watch body 620 and wearable band 610 can have independent power systems (e.g., power system 795 and 756, respectively) to enable each to operate independently. Watch body 620 and wearable band 610 can also share power (e.g., one can charge the other) via respective PMICs (e.g., PMICs 797 and 758) and charger inputs (e.g., 757 and 796) that can share power over power and ground conductors and/or over wireless charging antennas.

In some embodiments, peripherals interface 761 can include one or more sensors 721. Sensors 721 can include one or more coupling sensors 762 for detecting when watch body 620 is coupled with another electronic device (e.g., a wearable band 610). Sensors 721 can include one or more imaging sensors 763 (e.g., one or more of cameras 725, and/or separate imaging sensors 763 (e.g., thermal-imaging sensors)). In some embodiments, sensors 721 can include one or more SpO2 sensors 764. In some embodiments, sensors 721 can include one or more biopotential-signal sensors (e.g., EMG sensors 765, which may be disposed on an interior, user-facing portion of watch body 620 and/or wearable band 610). In some embodiments, sensors 721 may include one or more capacitive sensors 766. In some embodiments, sensors 721 may include one or more heart rate sensors 767. In some embodiments, sensors 721 may include one or more IMU sensors 768. In some embodiments, one or more IMU sensors 768 can be configured to detect movement of a user's hand or other location where watch body 620 is placed or held.

In some embodiments, one or more of sensors 721 may provide an example human-machine interface. For example, a set of neuromuscular sensors, such as EMG sensors 765, may be arranged circumferentially around wearable band 610 with an interior surface of EMG sensors 765 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 610 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 779. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 765 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 761 includes a near-field communication (NFC) component 769, a global-position system (GPS) component 770, a long-term evolution (LTE) component 771, and/or a Wi-Fi and/or Bluetooth communication component 772. In some embodiments, peripherals interface 761 includes one or more buttons 773 (e.g., peripheral buttons 623 and 627 in FIG. 6), which, when selected by a user, cause operation to be performed at watch body 620. In some embodiments, the peripherals interface 761 includes one or more indicators, such as a light emitting diode (LED), to provide a user with visual indicators (e.g., message received, low battery, active microphone and/or camera, etc.).

Watch body 620 can include at least one display 605 for displaying visual representations of information or data to a user, including user-interface elements and/or three-dimensional virtual objects. The display can also include a touch screen for inputting user inputs, such as touch gestures, swipe gestures, and the like. Watch body 620 can include at least one speaker 774 and at least one microphone 775 for providing audio signals to the user and receiving audio input from the user. The user can provide user inputs through microphone 775 and can also receive audio output from speaker 774 as part of a haptic event provided by haptic controller 778. Watch body 620 can include at least one camera 725, including a front camera 725a and a rear camera 725b. Cameras 725 can include ultra-wide-angle cameras, wide angle cameras, fish-eye cameras, spherical cameras, telephoto cameras, depth-sensing cameras, or other types of cameras.

Watch body computing system 760 can include one or more haptic controllers 778 and associated componentry (e.g., haptic devices 776) for providing haptic events at watch body 620 (e.g., a vibrating sensation or audio output in response to an event at the watch body 620). Haptic controllers 778 can communicate with one or more haptic devices 776, such as electroacoustic devices, including a speaker of the one or more speakers 774 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 778 can provide haptic events that are capable of being sensed by a user of watch body 620. In some embodiments, one or more haptic controllers 778 can receive input signals from an application of applications 782.

In some embodiments, wearable band computing system 730 and/or watch body computing system 760 can include memory 780, which can be controlled by one or more memory controllers of controllers 777. In some embodiments, software components stored in memory 780 include one or more applications 782 configured to perform operations at the watch body 620. In some embodiments, one or more applications 782 may include games, word processors, messaging applications, calling applications, web browsers, social media applications, media streaming applications, financial applications, calendars, clocks, etc. In some embodiments, software components stored in memory 780 include one or more communication interface modules 783 as defined above. In some embodiments, software components stored in memory 780 include one or more graphics modules 784 for rendering, encoding, and/or decoding audio and/or visual data and one or more data management modules 785 for collecting, organizing, and/or providing access to data 787 stored in memory 780. In some embodiments, one or more of applications 782 and/or one or more modules can work in conjunction with one another to perform various tasks at the watch body 620.

In some embodiments, software components stored in memory 780 can include one or more operating systems 781 (e.g., a Linux-based operating system, an Android operating system, etc.). Memory 780 can also include data 787. Data 787 can include profile data 788A, sensor data 789A, media content data 790, and application data 791.

It should be appreciated that watch body computing system 760 is an example of a computing system within watch body 620, and that watch body 620 can have more or fewer components than shown in watch body computing system 760, can combine two or more components, and/or can have a different configuration and/or arrangement of the components. The various components shown in watch body computing system 760 are implemented in hardware, software, firmware, or a combination thereof, including one or more signal processing and/or application-specific integrated circuits.

Turning to the wearable band computing system 730, one or more components that can be included in wearable band 610 are shown. Wearable band computing system 730 can include more or fewer components than shown in watch body computing system 760, can combine two or more components, and/or can have a different configuration and/or arrangement of some or all of the components. In some embodiments, all, or a substantial portion of the components of wearable band computing system 730 are included in a single integrated circuit. Alternatively, in some embodiments, components of wearable band computing system 730 are included in a plurality of integrated circuits that are communicatively coupled. As described above, in some embodiments, wearable band computing system 730 is configured to couple (e.g., via a wired or wireless connection) with watch body computing system 760, which allows the computing systems to share components, distribute tasks, and/or perform other operations described herein (individually or as a single device).

Wearable band computing system 730, similar to watch body computing system 760, can include one or more processors 749, one or more controllers 747 (including one or more haptics controllers 748), a peripherals interface 731 that can include one or more sensors 713 and other peripheral devices, a power source (e.g., a power system 756), and memory (e.g., a memory 750) that includes an operating system (e.g., an operating system 751), data (e.g., data 754 including profile data 788B, sensor data 789B, etc.), and one or more modules (e.g., a communications interface module 752, a data management module 753, etc.).

One or more of sensors 713 can be analogous to sensors 721 of watch body computing system 760. For example, sensors 713 can include one or more coupling sensors 732, one or more SpO2 sensors 734, one or more EMG sensors 735, one or more capacitive sensors 736, one or more heart rate sensors 737, and one or more IMU sensors 738.

Peripherals interface 731 can also include other components analogous to those included in peripherals interface 761 of watch body computing system 760, including an NFC component 739, a GPS component 740, an LTE component 741, a Wi-Fi and/or Bluetooth communication component 742, and/or one or more haptic devices 746 as described above in reference to peripherals interface 761. In some embodiments, peripherals interface 731 includes one or more buttons 743, a display 733, a speaker 744, a microphone 745, and a camera 755. In some embodiments, peripherals interface 731 includes one or more indicators, such as an LED.

It should be appreciated that wearable band computing system 730 is an example of a computing system within wearable band 610, and that wearable band 610 can have more or fewer components than shown in wearable band computing system 730, combine two or more components, and/or have a different configuration and/or arrangement of the components. The various components shown in wearable band computing system 730 can be implemented in one or more of a combination of hardware, software, or firmware, including one or more signal processing and/or application-specific integrated circuits.

Wrist-wearable device 600 with respect to FIG. 6 is an example of wearable band 610 and watch body 620 coupled together, so wrist-wearable device 600 will be understood to include the components shown and described for wearable band computing system 730 and watch body computing system 760. In some embodiments, wrist-wearable device 600 has a split architecture (e.g., a split mechanical architecture, a split electrical architecture, etc.) between watch body 620 and wearable band 610. In other words, all of the components shown in wearable band computing system 730 and watch body computing system 760 can be housed or otherwise disposed in a combined wrist-wearable device 600 or within individual components of watch body 620, wearable band 610, and/or portions thereof (e.g., a coupling mechanism 616 of wearable band 610).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 600 can be used in conjunction with a head-wearable device (e.g., AR system 800 and VR system 910) and/or an HIPD, and wrist-wearable device 600 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such as AR system 800 and VR system 910.

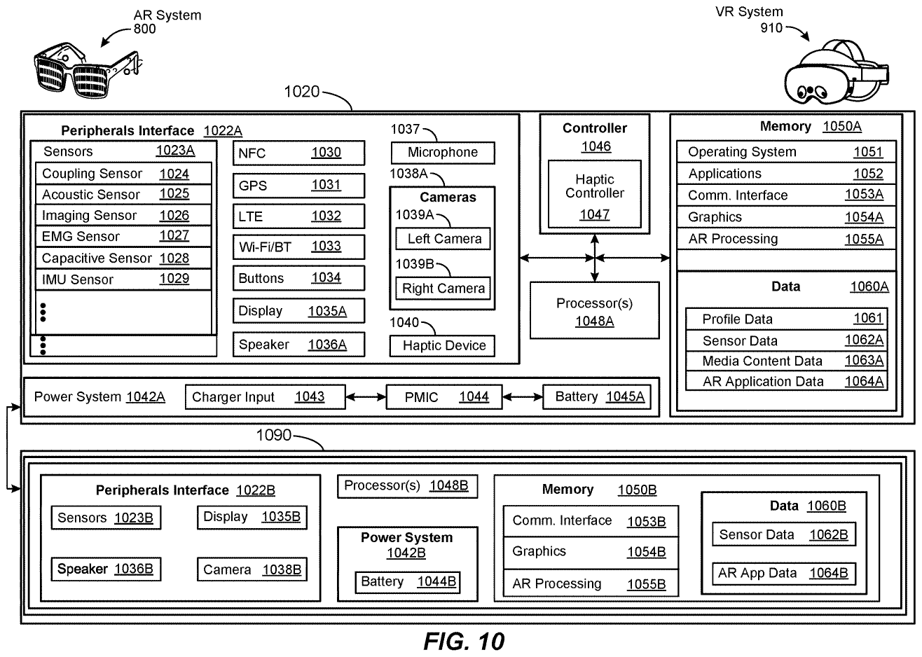

FIGS. 8 to 10 show example artificial-reality systems, which can be used as or in connection with wrist-wearable device 600. In some embodiments, AR system 800 includes an eyewear device 802, as shown in FIG. 8. In some embodiments, VR system 910 includes a head-mounted display (HMD) 912, as shown in FIGS. 9A and 9B. In some embodiments, AR system 800 and VR system 910 can include one or more analogous components (e.g., components for presenting interactive artificial-reality environments, such as processors, memory, and/or presentation devices, including one or more displays and/or one or more waveguides), some of which are described in more detail with respect to FIG. 10. As described herein, a head-wearable device can include components of eyewear device 802 and/or head-mounted display 912. Some embodiments of head-wearable devices do not include any displays, including any of the displays described with respect to AR system 800 and/or VR system 910. While the example artificial-reality systems are respectively described herein as AR system 800 and VR system 910, either or both of the example AR systems described herein can be configured to present fully-immersive virtual-reality scenes presented in substantially all of a user's field of view or subtler augmented-reality scenes that are presented within a portion, less than all, of the user's field of view.

FIG. 8 shows an example visual depiction of AR system 800, including an eyewear device 802 (which may also be described herein as augmented-reality glasses, and/or smart glasses). AR system 800 can include additional electronic components that are not shown in FIG. 8, such as a wearable accessory device and/or an intermediary processing device, in electronic communication or otherwise configured to be used in conjunction with the eyewear device 802. In some embodiments, the wearable accessory device and/or the intermediary processing device may be configured to couple with eyewear device 802 via a coupling mechanism in electronic communication with a coupling sensor 1024 (FIG. 10), where coupling sensor 1024 can detect when an electronic device becomes physically or electronically coupled with eyewear device 802. In some embodiments, eyewear device 802 can be configured to couple to a housing 1090 (FIG. 10), which may include one or more additional coupling mechanisms configured to couple with additional accessory devices. The components shown in FIG. 8 can be implemented in hardware, software, firmware, or a combination thereof, including one or more signal-processing components and/or application-specific integrated circuits (ASICs).

Eyewear device 802 includes mechanical glasses components, including a frame 804 configured to hold one or more lenses (e.g., one or both lenses 806-1 and 806-2). One of ordinary skill in the art will appreciate that eyewear device 802 can include additional mechanical components, such as hinges configured to allow portions of frame 804 of eyewear device 802 to be folded and unfolded, a bridge configured to span the gap between lenses 806-1 and 806-2 and rest on the user's nose, nose pads configured to rest on the bridge of the nose and provide support for eyewear device 802, earpieces configured to rest on the user's ears and provide additional support for eyewear device 802, temple arms configured to extend from the hinges to the earpieces of eyewear device 802, and the like. One of ordinary skill in the art will further appreciate that some examples of AR system 800 can include none of the mechanical components described herein. For example, smart contact lenses configured to present artificial reality to users may not include any components of eyewear device 802.

Eyewear device 802 includes electronic components, many of which will be described in more detail below with respect to FIG. 10. Some example electronic components are illustrated in FIG. 8, including acoustic sensors 825-1, 825-2, 825-3, 825-4, 825-5, and 825-6, which can be distributed along a substantial portion of the frame 804 of eyewear device 802. Eyewear device 802 also includes a left camera 839A and a right camera 839B, which are located on different sides of the frame 804. Eyewear device 802 also includes a processor 848 (or any other suitable type or form of integrated circuit) that is embedded into a portion of the frame 804.

FIGS. 9A and 9B show a VR system 910 that includes a head-mounted display (HMD) 912 (e.g., also referred to herein as an artificial-reality headset, a head-wearable device, a VR headset, etc.), in accordance with some embodiments. As noted, some artificial-reality systems (e.g., AR system 800) may, instead of blending an artificial reality with actual reality, substantially replace one or more of a user's visual and/or other sensory perceptions of the real world with a virtual experience (e.g., AR systems 400 and 500).

HMD 912 includes a front body 914 and a frame 916 (e.g., a strap or band) shaped to fit around a user's head. In some embodiments, front body 914 and/or frame 916 include one or more electronic elements for facilitating presentation of and/or interactions with an AR and/or VR system (e.g., displays, IMUs, tracking emitter or detectors). In some embodiments, HMD 912 includes output audio transducers (e.g., an audio transducer 918), as shown in FIG. 9B. In some embodiments, one or more components, such as the output audio transducer(s) 918 and frame 916, can be configured to attach and detach (e.g., are detachably attachable) to HMD 912 (e.g., a portion or all of frame 916, and/or audio transducer 918), as shown in FIG. 9B. In some embodiments, coupling a detachable component to HMD 912 causes the detachable component to come into electronic communication with HMD 912.

FIGS. 9A and 9B also show that VR system 910 includes one or more cameras, such as left camera 939A and right camera 939B, which can be analogous to left and right cameras 839A and 839B on frame 804 of eyewear device 802. In some embodiments, VR system 910 includes one or more additional cameras (e.g., cameras 939C and 939D), which can be configured to augment image data obtained by left and right cameras 939A and 939B by providing more information. For example, camera 939C can be used to supply color information that is not discerned by cameras 939A and 939B. In some embodiments, one or more of cameras 939A to 939D can include an optional IR cut filter configured to remove IR light from being received at the respective camera sensors.

FIG. 10 illustrates a computing system 1020 and an optional housing 1090, each of which show components that can be included in AR system 800 and/or VR system 910. In some embodiments, more or fewer components can be included in optional housing 1090 depending on practical restraints of the respective AR system being described.

In some embodiments, computing system 1020 can include one or more peripherals interfaces 1022A and/or optional housing 1090 can include one or more peripherals interfaces 1022B. Each of computing system 1020 and optional housing 1090 can also include one or more power systems 1042A and 1042B, one or more controllers 1046 (including one or more haptic controllers 1047), one or more processors 1048A and 1048B (as defined above, including any of the examples provided), and memory 1050A and 1050B, which can all be in electronic communication with each other. For example, the one or more processors 1048A and 1048B can be configured to execute instructions stored in memory 1050A and 1050B, which can cause a controller of one or more of controllers 1046 to cause operations to be performed at one or more peripheral devices connected to peripherals interface 1022A and/or 1022B. In some embodiments, each operation described can be powered by electrical power provided by power system 1042A and/or 1042B.

In some embodiments, peripherals interface 1022A can include one or more devices configured to be part of computing system 1020, some of which have been defined above and/or described with respect to the wrist-wearable devices shown in FIGS. 6 and 7. For example, peripherals interface 1022A can include one or more sensors 1023A. Some example sensors 1023A include one or more coupling sensors 1024, one or more acoustic sensors 1025, one or more imaging sensors 1026, one or more EMG sensors 1027, one or more capacitive sensors 1028, one or more IMU sensors 1029, and/or any other types of sensors explained above or described with respect to any other embodiments discussed herein.

In some embodiments, peripherals interfaces 1022A and 1022B can include one or more additional peripheral devices, including one or more NFC devices 1030, one or more GPS devices 1031, one or more LTE devices 1032, one or more Wi-Fi and/or Bluetooth devices 1033, one or more buttons 1034 (e.g., including buttons that are slidable or otherwise adjustable), one or more displays 1035A and 1035B, one or more speakers 1036A and 1036B, one or more microphones 1037, one or more cameras 1038A and 1038B (e.g., including the left camera 1039A and/or a right camera 1039B), one or more haptic devices 1040, and/or any other types of peripheral devices defined above or described with respect to any other embodiments discussed herein.

AR systems can include a variety of types of visual feedback mechanisms (e.g., presentation devices). For example, display devices in AR system 800 and/or VR system 910 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1035A and 1035B can be coupled to each of the lenses 806-1 and 806-2 of AR system 800. Displays 1035A and 1035B may be coupled to each of lenses 806-1 and 806-2, which can act together or independently to present an image or series of images to a user. In some embodiments, AR system 800 includes a single display 1035A or 1035B (e.g., a near-eye display) or more than two displays 1035A and 1035B. In some embodiments, a first set of one or more displays 1035A and 1035B can be used to present an augmented-reality environment, and a second set of one or more display devices 1035A and 1035B can be used to present a virtual-reality environment. In some embodiments, one or more waveguides are used in conjunction with presenting artificial-reality content to the user of AR system 800 (e.g., as a means of delivering light from one or more displays 1035A and 1035B to the user's eyes). In some embodiments, one or more waveguides are fully or partially integrated into the eyewear device 802. Additionally, or alternatively to display screens, some artificial-reality systems include one or more projection systems. For example, display devices in AR system 800 and/or VR system 910 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1035A and 1035B.

Computing system 1020 and/or optional housing 1090 of AR system 800 or VR system 910 can include some or all of the components of a power system 1042A and 1042B. Power systems 1042A and 1042B can include one or more charger inputs 1043, one or more PMICs 1044, and/or one or more batteries 1045A and 1044B.

Memory 1050A and 1050B may include instructions and data, some or all of which may be stored as non-transitory computer-readable storage media within the memories 1050A and 1050B. For example, memory 1050A and 1050B can include one or more operating systems 1051, one or more applications 1052, one or more communication interface applications 1053A and 1053B, one or more graphics applications 1054A and 1054B, one or more AR processing applications 1055A and 1055B, and/or any other types of data defined above or described with respect to any other embodiments discussed herein.

Memory 1050A and 1050B also include data 1060A and 1060B, which can be used in conjunction with one or more of the applications discussed above. Data 1060A and 1060B can include profile data 1061, sensor data 1062A and 1062B, media content data 1063A, AR application data 1064A and 1064B, and/or any other types of data defined above or described with respect to any other embodiments discussed herein.

In some embodiments, controller 1046 of eyewear device 802 may process information generated by sensors 1023A and/or 1023B on eyewear device 802 and/or another electronic device within AR system 800. For example, controller 1046 can process information from acoustic sensors 825-1 and 825-2. For each detected sound, controller 1046 can perform a direction of arrival (DOA) estimation to estimate a direction from which the detected sound arrived at eyewear device 802 of AR system 800. As one or more of acoustic sensors 1025 (e.g., the acoustic sensors 825-1, 825-2) detects sounds, controller 1046 can populate an audio data set with the information (e.g., represented in FIG. 10 as sensor data 1062A and 1062B).

In some embodiments, a physical electronic connector can convey information between eyewear device 802 and another electronic device and/or between one or more processors 848, 1048A, 1048B of AR system 800 or VR system 910 and controller 1046. The information can be in the form of optical data, electrical data, wireless data, or any other transmittable data form. Moving the processing of information generated by eyewear device 802 to an intermediary processing device can reduce weight and heat in the eyewear device, making it more comfortable and safer for a user. In some embodiments, an optional wearable accessory device (e.g., an electronic neckband) is coupled to eyewear device 802 via one or more connectors. The connectors can be wired or wireless connectors and can include electrical and/or non-electrical (e.g., structural) components. In some embodiments, eyewear device 802 and the wearable accessory device can operate independently without any wired or wireless connection between them.

In some situations, pairing external devices, such as an intermediary processing device (e.g., HIPD 206, 306, 406) with eyewear device 802 (e.g., as part of AR system 800) enables eyewear device 802 to achieve a similar form factor of a pair of glasses while still providing sufficient battery and computation power for expanded capabilities. Some, or all, of the battery power, computational resources, and/or additional features of AR system 800 can be provided by a paired device or shared between a paired device and eyewear device 802, thus reducing the weight, heat profile, and form factor of eyewear device 802 overall while allowing eyewear device 802 to retain its desired functionality. For example, the wearable accessory device can allow components that would otherwise be included on eyewear device 802 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 802 standing alone. Because weight carried in the wearable accessory device can be less invasive to a user than weight carried in the eyewear device 802, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 800 and/or VR system 910 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 9A and 9B show VR system 910 having cameras 939A to 939D, which can be used to provide depth information for creating a voxel field and a two-dimensional mesh to provide object information to the user to avoid collisions.

In some embodiments, AR system 800 and/or VR system 910 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 800 and/or VR system 910, ambient light (e.g., a live feed of the surrounding environment that a user would normally see) can be passed through a display element of a respective head-wearable device presenting aspects of the AR system. In some embodiments, ambient light can be passed through a portion that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

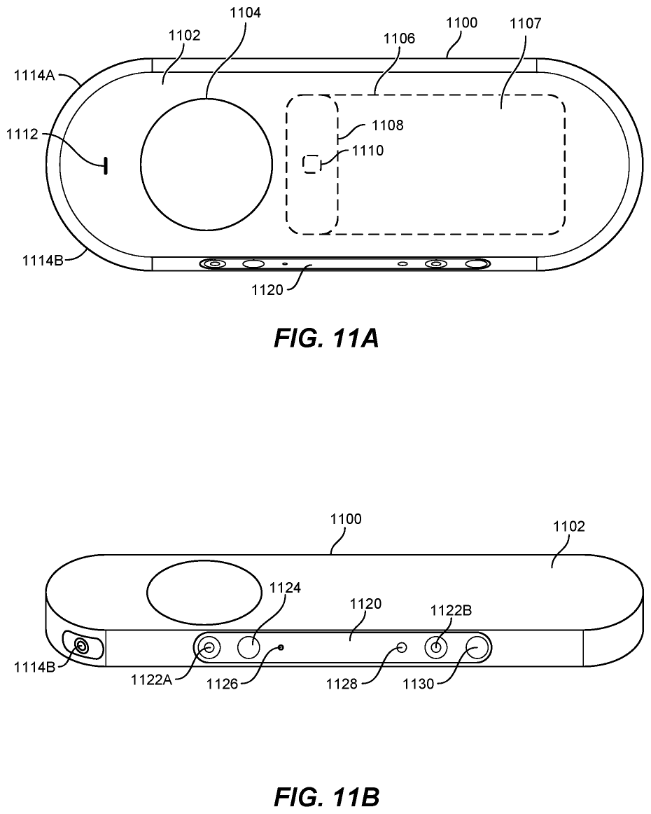

FIGS. 11A and 11B illustrate an example handheld intermediary processing device (HIPD) 1100 in accordance with some embodiments. HIPD 1100 is an instance of the intermediary device described herein, such that HIPD 1100 should be understood to have the features described with respect to any intermediary device defined above or otherwise described herein and vice versa. FIG. 11A shows a top view and FIG. 11B shows a side view of the HIPD 1100. HIPD 1100 is configured to communicatively couple with one or more wearable devices (or other electronic devices) associated with a user. For example, HIPD 1100 is configured to communicatively couple with a user's wrist-wearable device 202, 302 (or components thereof, such as watch body 620 and wearable band 610), AR system 800, and/or VR headset 450 and 900. HIPD 1100 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 1100 can successfully be communicatively coupled with an electronic device, such as a wearable device).

HIPD 1100 can perform various functions independently and/or in conjunction with one or more wearable devices (e.g., wrist-wearable device 202, AR system 800, VR system 910, etc.). HIPD 1100 can be configured to increase and/or improve the functionality of communicatively coupled devices, such as the wearable devices. HIPD 1100 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 2-4B. Additionally, as will be described in more detail below, functionality and/or operations of HIPD 1100 can include, without limitation, task offloading and/or handoffs; thermals offloading and/or handoffs; six degrees of freedom (6DoF) raycasting and/or gaming (e.g., using imaging devices or cameras 1114A, 1114B, which can be used for simultaneous localization and mapping (SLAM) and/or with other image processing techniques), portable charging, messaging, image capturing via one or more imaging devices or cameras 1122A and 1122B, sensing user input (e.g., sensing a touch on a touch input surface 1102), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 1100 and/or in communication between HIPD 1100 and another wearable device described herein. In some embodiments, functions can be executed on HIPD 1100 in conjunction with an AR environment. As the skilled artisan will appreciate upon reading the descriptions provided herein that HIPD 1100 can be used with any type of suitable AR environment.

While HIPD 1100 is communicatively coupled with a wearable device and/or other electronic device, HIPD 1100 is configured to perform one or more operations initiated at the wearable device and/or the other electronic device. In particular, one or more operations of the wearable device and/or the other electronic device can be offloaded to HIPD 1100 to be performed. HIPD 1100 performs the one or more operations of the wearable device and/or the other electronic device and provides to data corresponded to the completed operations to the wearable device and/or the other electronic device. For example, a user can initiate a video stream using AR system 800 and back-end tasks associated with performing the video stream (e.g., video rendering) can be offloaded to HIPD 1100, which HIPD 1100 performs and provides corresponding data to AR system 800 to perform remaining front-end tasks associated with the video stream (e.g., presenting the rendered video data via a display of AR system 800). In this way, HIPD 1100, which has more computational resources and greater thermal headroom than a wearable device, can perform computationally intensive tasks for the wearable device, thereby improving performance of an operation performed by the wearable device.

HIPD 1100 includes a multi-touch input surface 1102 on a first side (e.g., a front surface) that is configured to detect one or more user inputs. In particular, multi-touch input surface 1102 can detect single tap inputs, multi-tap inputs, swipe gestures and/or inputs, force-based and/or pressure-based touch inputs, held taps, and the like. Multi-touch input surface 1102 is configured to detect capacitive touch inputs and/or force (and/or pressure) touch inputs. Multi-touch input surface 1102 includes a first touch-input surface 1104 defined by a surface depression and a second touch-input surface 1106 defined by a substantially planar portion. First touch-input surface 1104 can be disposed adjacent to second touch-input surface 1106. In some embodiments, first touch-input surface 1104 and second touch-input surface 1106 can be different dimensions and/or shapes. For example, first touch-input surface 1104 can be substantially circular and second touch-input surface 1106 can be substantially rectangular. In some embodiments, the surface depression of multi-touch input surface 1102 is configured to guide user handling of HIPD 1100. In particular, the surface depression can be configured such that the user holds HIPD 1100 upright when held in a single hand (e.g., such that the using imaging devices or cameras 1114A and 1114B are pointed toward a ceiling or the sky). Additionally, the surface depression is configured such that the user's thumb rests within first touch-input surface 1104.

In some embodiments, the different touch-input surfaces include a plurality of touch-input zones. For example, second touch-input surface 1106 includes at least a second touch-input zone 1108 within a first touch-input zone 1107 and a third touch-input zone 1110 within second touch-input zone 1108. In some embodiments, one or more of touch-input zones 1108 and 1110 are optional and/or user defined (e.g., a user can specific a touch-input zone based on their preferences). In some embodiments, each touch-input surface 1104 and 1106 and/or touch-input zone 1108 and 1110 are associated with a predetermined set of commands. For example, a user input detected within first touch-input zone 1108 may cause HIPD 1100 to perform a first command and a user input detected within second touch-input surface 1106 may cause HIPD 1100 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 1108 can be configured to detect force touch inputs (e.g., a magnitude at which the user presses down) and capacitive touch inputs, and second touch-input zone 1110 can be configured to detect capacitive touch inputs.

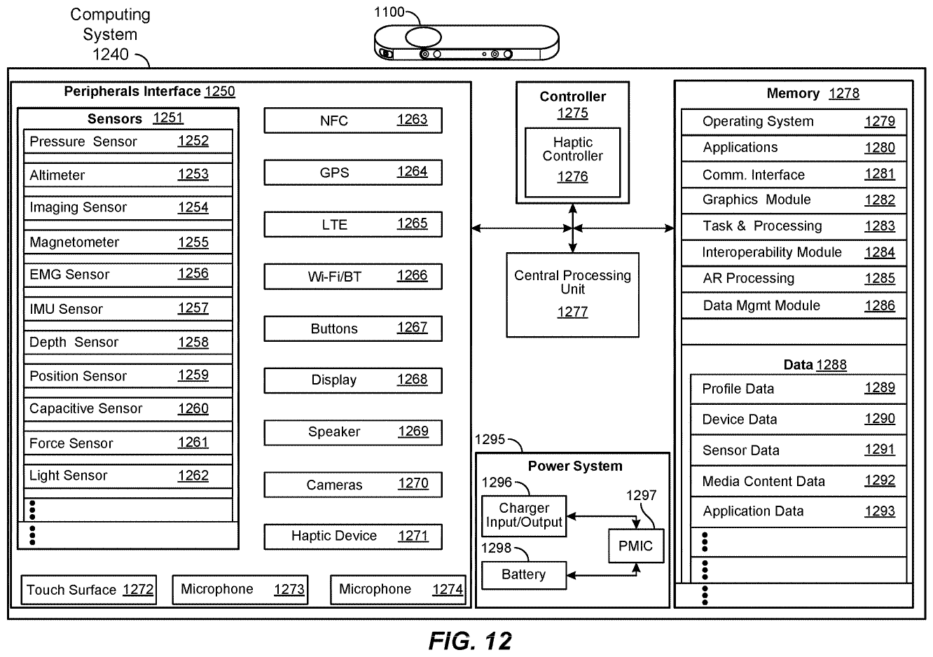

As shown in FIG. 12, HIPD 1100 includes one or more sensors 1251 for sensing data used in the performance of one or more operations and/or functions. For example, HIPD 1100 can include an IMU sensor that is used in conjunction with cameras 1114A, 1114B (FIGS. 11A-11B) for 3-dimensional object manipulation (e.g., enlarging, moving, destroying, etc., an object) in an AR or VR environment. Non-limiting examples of sensors 1251 included in HIPD 1100 include a light sensor, a magnetometer, a depth sensor, a pressure sensor, and a force sensor.

HIPD 1100 can include one or more light indicators 1112 to provide one or more notifications to the user. In some embodiments, light indicators 1112 are LEDs or other types of illumination devices. Light indicators 1112 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 1104. Light indicators 1112 can be illuminated in different colors and/or patterns to provide the user with one or more notifications and/or information about the device. For example, a light indicator positioned around first touch-input surface 1104 may flash when the user receives a notification (e.g., a message), change red when HIPD 1100 is out of power, operate as a progress bar (e.g., a light ring that is closed when a task is completed (e.g., 0% to 100%)), operate as a volume indicator, etc.

In some embodiments, HIPD 1100 includes one or more additional sensors on another surface. For example, as shown FIG. 11A, HIPD 1100 includes a set of one or more sensors (e.g., sensor set 1120) on an edge of HIPD 1100. Sensor set 1120, when positioned on an edge of the of HIPD 1100, can be pe positioned at a predetermined tilt angle (e.g., 26 degrees), which allows sensor set 1120 to be angled toward the user when placed on a desk or other flat surface. Alternatively, in some embodiments, sensor set 1120 is positioned on a surface opposite the multi-touch input surface 1102 (e.g., a back surface). The one or more sensors of sensor set 1120 are discussed in further detail below.

The side view of the of HIPD 1100 in FIG. 11B shows sensor set 1120 and camera 1114B. Sensor set 1120 can include one or more cameras 1122A and 1122B, a depth projector 1124, an ambient light sensor 1128, and a depth receiver 1130. In some embodiments, sensor set 1120 includes a light indicator 1126. Light indicator 1126 can operate as a privacy indicator to let the user and/or those around them know that a camera and/or microphone is active. Sensor set 1120 is configured to capture a user's facial expression such that the user can puppet a custom avatar (e.g., showing emotions, such as smiles, laughter, etc., on the avatar or a digital representation of the user). Sensor set 1120 can be configured as a side stereo RGB system, a rear indirect Time-of-Flight (iToF) system, or a rear stereo RGB system. As the skilled artisan will appreciate upon reading the descriptions provided herein, HIPD 1100 described herein can use different sensor set 1120 configurations and/or sensor set 1120 placement.

Turning to FIG. 12, in some embodiments, a computing system 1240 of HIPD 1100 can include one or more haptic devices 1271 (e.g., a vibratory haptic actuator) that are configured to provide haptic feedback (e.g., kinesthetic sensation). Sensors 1251 and/or the haptic devices 1271 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 1100 is configured to operate without a display. However, optionally, computing system 1240 of the HIPD 1100 can include a display 1268. HIPD 1100 can also include one or more optional peripheral buttons 1267. For example, peripheral buttons 1267 can be used to turn on or turn off HIPD 1100. Further, HIPD 1100 housing can be formed of polymers and/or elastomers. In other words, HIPD 1100 may be designed such that it would not easily slide off a surface. In some embodiments, HIPD 1100 includes one or magnets to couple HIPD 1100 to another surface. This allows the user to mount HIPD 1100 to different surfaces and provide the user with greater flexibility in use of HIPD 1100.

As described above, HIPD 1100 can distribute and/or provide instructions for performing the one or more tasks at HIPD 1100 and/or a communicatively coupled device. For example, HIPD 1100 can identify one or more back-end tasks to be performed by HIPD 1100 and one or more front-end tasks to be performed by a communicatively coupled device. While HIPD 1100 is configured to offload and/or handoff tasks of a communicatively coupled device, HIPD 1100 can perform both back-end and front-end tasks (e.g., via one or more processors, such as CPU 1277). HIPD 1100 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 1100 can perform the above operations alone or in conjunction with a wearable device (or other communicatively coupled electronic device).

FIG. 12 shows a block diagram of a computing system 1240 of HIPD 1100 in accordance with some embodiments. HIPD 1100, described in detail above, can include one or more components shown in HIPD computing system 1240. HIPD 1100 will be understood to include the components shown and described below for HIPD computing system 1240. In some embodiments, all, or a substantial portion of the components of HIPD computing system 1240 are included in a single integrated circuit. Alternatively, in some embodiments, components of HIPD computing system 1240 are included in a plurality of integrated circuits that are communicatively coupled.

HIPD computing system 1240 can include a processor (e.g., a CPU 1277, a GPU, and/or a CPU with integrated graphics), a controller 1275, a peripherals interface 1250 that includes one or more sensors 1251 and other peripheral devices, a power source (e.g., a power system 1295), and memory (e.g., a memory 1278) that includes an operating system (e.g., an operating system 1279), data (e.g., data 1288), one or more applications (e.g., applications 1280), and one or more modules (e.g., a communications interface module 1281, a graphics module 1282, a task and processing management module 1283, an interoperability module 1284, an AR processing module 1285, a data management module 1286, etc.). HIPD computing system 1240 further includes a power system 1295 that includes a charger input and output 1296, a PMIC 1297, and a battery 1298, all of which are defined above.

In some embodiments, peripherals interface 1250 can include one or more sensors 1251. Sensors 1251 can include analogous sensors to those described above in reference to FIG. 6. For example, sensors 1251 can include imaging sensors 1254, (optional) EMG sensors 1256, IMU sensors 1258, and capacitive sensors 1260. In some embodiments, sensors 1251 can include one or more pressure sensors 1252 for sensing pressure data, an altimeter 1253 for sensing an altitude of the HIPD 1100, a magnetometer 1255 for sensing a magnetic field, a depth sensor 1257 (or a time-of flight sensor) for determining a difference between the camera and the subject of an image, a position sensor 1259 (e.g., a flexible position sensor) for sensing a relative displacement or position change of a portion of the HIPD 1100, a force sensor 1261 for sensing a force applied to a portion of the HIPD 1100, and a light sensor 1262 (e.g., an ambient light sensor) for detecting an amount of lighting. Sensors 1251 can include one or more sensors not shown in FIG. 12.

Analogous to the peripherals described above in reference to FIG. 6, peripherals interface 1250 can also include an NFC component 1263, a GPS component 1264, an LTE component 1265, a Wi-Fi and/or Bluetooth communication component 1266, a speaker 1269, a haptic device 1271, and a microphone 1273. As noted above, HIPD 1100 can optionally include a display 1268 and/or one or more peripheral buttons 1267. Peripherals interface 1250 can further include one or more cameras 1270, touch surfaces 1272, and/or one or more light emitters 1274. Multi-touch input surface 1102 described above in reference to FIGS. 11A and 11B is an example of touch surface 1272. Light emitters 1274 can be one or more LEDs, lasers, etc. and can be used to project or present information to a user. For example, light emitters 1274 can include light indicators 1112 and 1126 described above in reference to FIGS. 11A and 11B. Cameras 1270 (e.g., cameras 1114A, 1114B, 1122A, and 1122B described above in reference to FIGS. 11A and 11B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 1270 can be used for SLAM, 6DoF ray casting, gaming, object manipulation and/or other rendering, facial recognition and facial expression recognition, etc.

Similar to watch body computing system 760 and watch band computing system 730 described above in reference to FIG. 7, HIPD computing system 1240 can include one or more haptic controllers 1276 and associated componentry (e.g., haptic devices 1271) for providing haptic events at HIPD 1100.

Memory 1278 can include high-speed random-access memory and/or non-volatile memory, such as one or more magnetic disk storage devices, flash memory devices, or other non-volatile solid-state memory devices. Access to memory 1278 by other components of HIPD 1100, such as the one or more processors and peripherals interface 1250, can be controlled by a memory controller of controllers 1275.

In some embodiments, software components stored in memory 1278 include one or more operating systems 1279, one or more applications 1280, one or more communication interface modules 1281, one or more graphics modules 1282, and/or one or more data management modules 1286, which are analogous to the software components described above in reference to FIG. 6.

In some embodiments, software components stored in memory 1278 include a task and processing management module 1283 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 1283 uses data 1288 (e.g., device data 1290) to distribute the one or more front-end and/or back-end tasks based on communicatively coupled devices' computing resources, available power, thermal headroom, ongoing operations, and/or other factors. For example, task and processing management module 1283 can cause the performance of one or more back-end tasks (of an operation performed at communicatively coupled AR system 800) at HIPD 1100 in accordance with a determination that the operation is utilizing a predetermined amount (e.g., at least 70%) of computing resources available at AR system 800.

In some embodiments, software components stored in memory 1278 include an interoperability module 1284 for exchanging and utilizing information received and/or provided to distinct communicatively coupled devices. Interoperability module 1284 allows for different systems, devices, and/or applications to connect and communicate in a coordinated way without user input. In some embodiments, software components stored in memory 1278 include an AR processing module 1285 that is configured to process signals based at least on sensor data for use in an AR and/or VR environment. For example, AR processing module 1285 can be used for 3D object manipulation, gesture recognition, facial and facial expression recognition, etc.

Memory 1278 can also include data 1288. In some embodiments, data 1288 can include profile data 1289, device data 1290 (including device data of one or more devices communicatively coupled with HIPD 1100, such as device type, hardware, software, configurations, etc.), sensor data 1291, media content data 1292, and application data 1293.

It should be appreciated that HIPD computing system 1240 is an example of a computing system within HIPD 1100, and that HIPD 1100 can have more or fewer components than shown in HIPD computing system 1240, combine two or more components, and/or have a different configuration and/or arrangement of the components. The various components shown HIPD computing system 1240 are implemented in hardware, software, firmware, or a combination thereof, including one or more signal processing and/or application-specific integrated circuits.

The techniques described above in FIGS. 11A, 11B, and 12 can be used with any device used as a human-machine interface controller. In some embodiments, an HIPD 1100 can be used in conjunction with one or more wearable device such as a head-wearable device (e.g., AR system 800 and VR system 910) and/or a wrist-wearable device 600 (or components thereof).

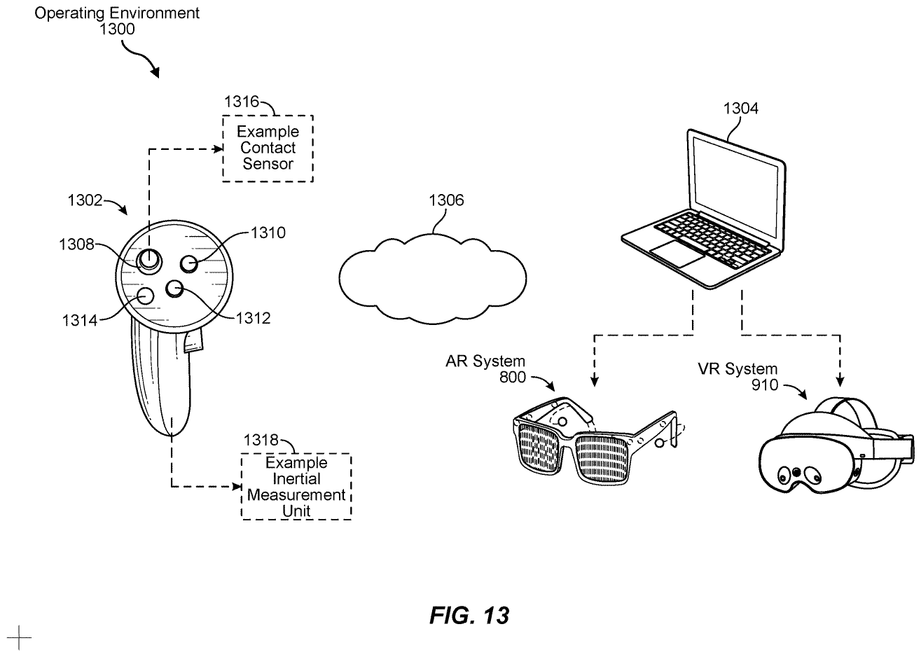

FIG. 13 illustrates operating environment 1300 in which an example handheld device 1302 can implement various techniques of the corrective input data generation system of the present disclosure, according to some aspects described and illustrated herein. In aspects, example operating environment 1300 can include example handheld device 1302 that is communicatively coupled to example computing device 1304 via communication network 1306.

In some aspects, example handheld device 1302 can correspond to a gaming controller that includes a plurality of user-actuatable input components disposed on the upper face of the controller such that a user can actuate these components with one or both thumbs while maintaining a grip on device 1302. In aspects, example handheld device 1302 can include at least one handle with a compressible button or trigger disposed thereupon and internal circuitry configured to detect, process, and communicate input data generated in response to user interaction with at least one of the input components.

The plurality of user-actuatable input components can include an input actuator in the form of analog joystick 1308 (referred to herein as “joystick 1308” or “joystick”) that generates directional input based on physical movement by the user. For example, joystick 1308 can be movable in multiple directions, including forward, backward, leftward, rightward, diagonal, arcuate, rotational motion, tilt motion, and so forth. Analog joystick 1308 can also be depressible to provide a button-type input. Further, movement of the joystick can be converted into coordinate data, such as X-Y position data, which is usable for controlling movement of an element or object included as part of a digital scene output on a display of, e.g., example computing device 1304.

In some aspects, the plurality of user-actuatable input components can further include face buttons 1310, 1312 disposed on the upper face of example handheld device 1302. These can be physically separate from analog joystick 1308 and correspond to respective binary or multi-state input buttons. In aspects, these face buttons can be arranged in a cluster positioned to be reachable by a thumb of the user while the user maintains a grasp on example handheld device 1302. The discrete face buttons can be used to initiate commands, select options, confirm inputs, trigger in-application actions, or otherwise supplement directional input provided by analog joystick 1308. By providing discrete face buttons in addition to the joystick, example handheld device 1302 can support a combination of directional control and discrete command entry.

In some aspects, the plurality of user-actuatable input components can also include system input button 1314 disposed on the upper face of example handheld device 1302. This button can be configured to invoke one or more system-level operations of example handheld device 1302. For example, system input button 1314 can be used to power on example handheld device 1302, wake example handheld device 1302, invoke a system menu, initiate pairing, return to a home interface, or otherwise request an operating-system-level or controller-management function rather than an application-specific command. In aspects, system input button 1314 can be positioned centrally or in another location that reduces inadvertent actuation while remaining accessible to the user.

In some aspects, the arrangement of analog joystick 1308, face buttons 1310, 1312, and system input button 1314 facilitates one-handed or two-handed interaction with example handheld device 1302. For example, a user can manipulate analog joystick 1308 with a thumb while selectively actuating at least one of face buttons 1310, 1312 or system input button 1314 with the same thumb or another thumb. In aspects, analog joystick 1308 can include example contact sensor 1316 configured to generate analog position data representing movement of the analog joystick 1308 along an x-axis and a y-axis. In some aspects, example contact sensor 1316 can include one or more rotary potentiometers, such as a first rotary potentiometer associated with the x-axis and a second rotary potentiometer associated with the y-axis such that a movement of the analog joystick 1308 causes respective wipers to move across resistive tracks and generate variable electrical signals corresponding to joystick position.

In some aspects, analog joystick 1308 can additionally or alternatively include example contact sensor 1316—linear potentiometers arranged such that movement of analog joystick 1308 can produce linear displacement of one or more sliders relative to respective resistive elements, thereby generating analog signals representative of displacement along the x-axis and the y-axis. In aspects, the potentiometers may be implemented as carbon-track potentiometers, conductive-plastic potentiometers, or cermet potentiometers, each of which may operate as a contact sensor through physical interaction between a movable contact element and a resistive sensing element.

In some aspects, example sensor 1316 can include one or more contact-based force-sensitive resistive sensor arrangements configured to detect force, pressure, or deflection associated with user actuation of analog joystick 1308. For example, multiple resistive sensing elements may be distributed about a joystick support structure such that differential outputs from the resistive sensing elements are processed to determine directional input corresponding to the x-axis and the y-axis. In some aspects, outputs from any of the foregoing contact-based sensing arrangements may be combined to generate an x-value and a y-value that together define an x-y coordinate data point representative of a two-dimensional position of the analog joystick 1308 within a particular environment, e.g., a virtual or digital game output on the display of example computing device 1304.

In some aspects, example handheld device 1302 can further include motion sensors, such as example inertial measurement unit 1318 (“IMU 1318”), disposed within the housing of example handheld device 1302 and configured to detect movement or orientation of example handheld device 1302. Some movement can include forward, backward, leftward, rightward, diagonal, arcuate, rotational motion, tilt motion, and so forth. An inertial measurement unit (IMU) is an electronic sensor assembly configured to detect motion-related characteristics of a device, e.g., example handheld device 1302. An IMU can include one or more accelerometers configured to detect linear acceleration and one or more gyroscopes configured to detect angular velocity. In some aspects, the IMU can further include a magnetometer configured to detect orientation relative to a magnetic field. Signals generated by the accelerometer, gyroscope, and, so forth, can be processed to determine movement, tilt, rotation, acceleration, or orientation of example handheld device 1302.

In some aspects, computing device 1304 can include one or more processors, memory, a communication interface, and a peripherals interface. The memory can store applications, operating system components, sensor data, application data, and instructions executable by the one or more processors. Through the communication interface, computing device 1304 can exchange data with handheld device 1302 and, in some aspects, another system, such as AR system 800 and VR system 910. In other aspects, example computing device 1304 can correspond to either AR system 800 or VR system 910. Alternatively, example computing device 1304 can include AR system 800 or VR system 910 operating in conjunction with another computing device.

In aspects, communication network 1306 communicatively couples analog joystick 1308 and example handheld device 1302 to computing device 1304 such that input information generated in response to user actuation of analog joystick 1308 can be communicated to computing device 1304 for downstream processing operations. Communication network 1306 can be implemented using one or more communication interfaces of the participating devices and can support one or more wireless communication technologies, such as Wi-Fi, Bluetooth, near-field communication, cellular communication, or a combination thereof. In aspects, communication network 1306 can correspond to a short-range communication link used for controller communications, a broader communication network used for communication with another system, or a combination thereof.

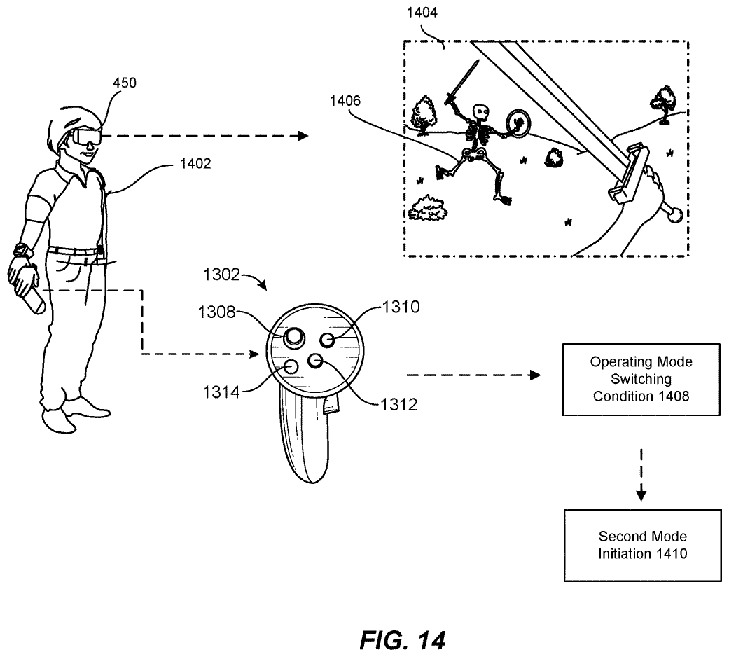

FIG. 14 illustrates the detection of an operating mode switching condition via implementation of the corrective input data generation system of the present disclosure, according to some aspects described and illustrated herein. Specifically, FIG. 14 illustrates a user (e.g., example gamer 1402) interacting with example game 1402 using example handheld device 1302. In aspects, example game 1404 can be output as part of an AR or VR environment accessible via VR headset 450 worn by example gamer 1402. In other aspects, example game 1404 can be presented, output, or rendered in a display of a computing device that is communicatively coupled to example handheld device 1302. In this scenario, example gamer 1402 may not be wearing VR headset 450, interacting instead, directly with, e.g., a digital character included in example game 1404.

For example, example gamer 1402 may move analog joystick 1308 in various directions, e.g., left, right, forwards, backwards, and so forth, and view digital character 1406 moving in respective corresponding directions. While example gamer 1402 is interacting with example game 1404, example handheld device 1302 may be operating in a first mode. In aspects, when operating in this mode, analog joystick 1308 serves as an input actuator that provides directional control input to example game 1404 to enable example gamer 1402 to control movement of digital character 1406. In this mode, a processor or other computing circuitry of handheld device 1302 can receive first motion data from analog joystick 1308, which represents physical movement of analog joystick 1308 performed by example gamer 1402. Specifically, when example gamer 1402 moves analog joystick 1308 leftward, rightward, forward, backward, diagonally, or in another direction, contact sensor 1316 associated with analog joystick 1308 can generate electrical signals corresponding to each gamer movement. Example handheld device 1302 may then process these electrical signals as first motion data for controlling digital character 1406 or another element included in example game 1404.

In some aspects, the first motion data can correspond to a first data format associated with analog joystick 1308. For example, contact sensor 1316 can include a first sensing arrangement (e.g., sensor) associated with an x-axis and a second sensing arrangement associated (e.g., sensor) with a y-axis (as described above with respect to FIG. 13) such that movement of analog joystick 1308 along the x-axis produces a first value and movement of analog joystick 1308 along the y-axis produces a second value. Example handheld device 1302 can combine the first value and the second value into an x-y coordinate pair representative of an instantaneous position of analog joystick 1308. Over time, handheld device 1302 can receive a plurality of coordinate values from analog joystick 1308, each coordinate value including a first value along the x-axis and a second value along the y-axis, such that the plurality of coordinate values defines a stream of first motion data corresponding to successive positions of analog joystick 1308 during gameplay. Each coordinate value having a first value along the x-axis and a second value along the y-axis can represent a first data format specific to the input actuator (e.g., analog joystick 1308).

In some aspects, example handheld device 1302 can determine whether operating mode switching condition 1408 has been satisfied with respect to analog joystick 1308, namely while example handheld device 1302 is operating in the first mode. In aspects, operating mode switching condition 1408 can be satisfied (e.g., automatically and without user intervention) based on effectiveness of a current operating condition of analog joystick 1308. Alternatively, the switching condition 1408 can be satisfied based on user selection, e.g., example gamer 1402 selecting an icon or option displayed, e.g., on a user interface output on example computing device 1304, that places example handheld device 1302 in a second operating mode.

For example, with respect to the automatic satisfaction of operating mode switching condition 1408, analog joystick 1308 operating in conjunction with example computing device 1304 may analyze the first motion data received from analog joystick 1308, and determine whether analog joystick 1308 continues to provide reliable directional input for example game 1404. When operating mode switching condition 1408 is not satisfied, example handheld device 1302 can continue operating in the first mode such that input corresponding to analog joystick 1308 remains the main control input that facilitates example gamer 1402 to control movement of digital character 1406. When operating mode switching condition 1408 is satisfied, example handheld device 1302 can initiate operation in a second mode.

In some aspects, determining whether the operating mode switching condition 1408 is automatically satisfied can include determining whether analog joystick 1308 satisfies a degradation parameter. The degradation parameter can correspond to a malfunction condition associated with analog joystick 1308, such as analog stick drift, analog stick failure, or another condition indicating that analog joystick 1308 is improperly functioning. By way of example, handheld device 1302 can determine that the degradation parameter is satisfied when analog joystick 1308 exhibits drift relative to an expected default position, when analog joystick 1308 fails to provide expected directional input in response to user actuation, or when first motion data generated by analog joystick 1308 indicates an unreliable control state. In such aspects, satisfaction of the degradation parameter can indicate that continued reliance on analog joystick 1308 in the first operating mode is undesirable.

In some aspects, the degradation parameter can correspond to a value, threshold, or value range indicative of whether analog joystick 1308 is functioning properly or improperly. For example, the degradation parameter can correspond to a magnitude of deviation of the first motion data from an expected neutral position, a persistence duration of unintended non-zero x-axis or y-axis output, a frequency of erroneous coordinate reports, a variance value associated with unstable joystick output, or another metric indicative of drift, failure, or degraded operation. In aspects, example handheld device 1302 can determine that the degradation parameter is satisfied when the metric equals or exceeds a threshold value, falls outside an expected operating range, or remains within a failure range for at least a threshold period of time.

By way of example, an expected operating range can correspond to coordinate values at or near a neutral x-y coordinate pair when analog joystick 1308 is not being actuated, whereas a degradation range can correspond to coordinate values that remain offset from the neutral x-y coordinate pair absent intended user input. In some aspects, the degradation parameter can, in some cases, be binary, such as a non-degraded-state value and a degraded-state value, or multi-level, such as a first range corresponding to non-degraded operation, a second range corresponding to a warning condition, and a third range corresponding to a failover condition. Accordingly, the degradation parameter can be used to determine whether the operating mode switching condition is satisfied based on whether first motion data generated by analog joystick 1308 falls within, exceeds, or otherwise corresponds to a value or range associated with degraded input actuator performance.

In aspects, satisfaction of operation mode switching condition 1408 (e.g., another way of determining whether the operating mode switching condition is satisfied) can be based on receiving a user selection for initiating operation in the second mode. For example, example handheld device 1302 operating in conjunction with computing device 1304, can present a user-selectable icon on a display of, e.g., example computing device 1304. This icon may state “Initiate Second Mode” and example gamer 1402 may select this icon using one or more input buttons of example handheld device 1302 to initiate operation of device 1302 in the second mode (e.g., second mode initiation 1410.

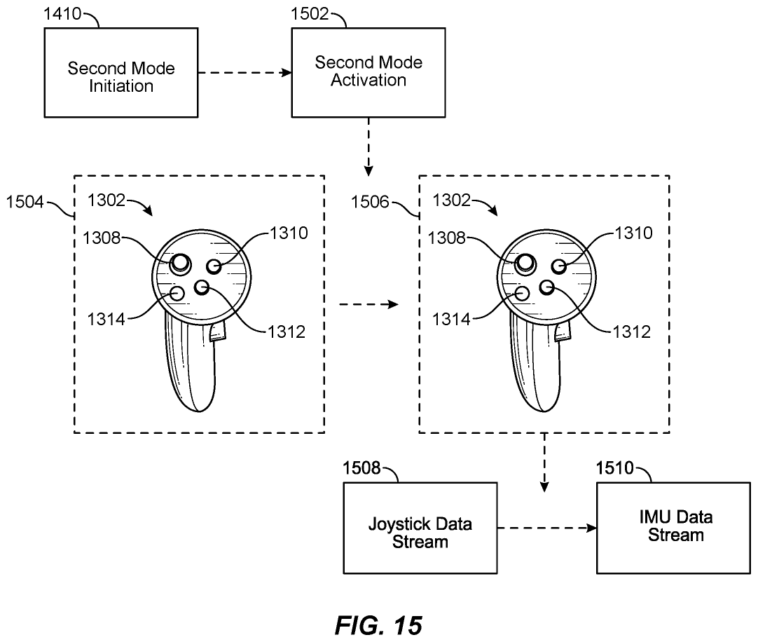

FIG. 15 describes activation of example handheld device 1302 in a second mode by the corrective input data generation system of the present disclosure, according to some aspects described and illustrated herein. In some aspects, initiation of operation of example handheld device 1302 in the second mode can be distinguished from activation of operation of example handheld device 1302 in the second mode. For example, initiation of the second mode can occur when example handheld device 1302 determines that operating mode switching condition 1408 is satisfied with respect to analog joystick 1308, e.g., based on satisfaction of a degradation parameter associated with analog joystick 1308 or based on receipt of a user selection to place handheld device 1302 in the second mode. In such aspects, initiation can correspond to enabling, invoking, or otherwise causing the second mode to become available for use by example handheld device 1302. In contrast, activation of the second mode can correspond to actual engagement of second-mode operation after the second mode has been initiated or otherwise made available.

As such, activation of operation of example handheld device 1302 in the second mode (second mode activation 1502) can occur at least in part based on and responsive to satisfaction of operating mode switching condition 1408. In one example, after operating mode switching condition 1408 has been satisfied, example gamer 1402 can implement or perform at least a specific action or a specific set of actions that result in the corrective input data generation system of the present disclosure activating operation of example handheld device 1302 in the second mode. In aspects, these actions can include (1) example gamer 1402 contacting analog joystick 1308 (1504) and (2) tilting or moving example handheld device 1302 in a particular direction (1506), e.g., left, right, forward, backward, and so forth. In aspects, these two actions, performed, e.g., simultaneously, sequentially, or within a particular time interval, may enable the corrective input data generation system of the present disclosure (which may include example handheld device 1302 operating in conjunction with example computing device 1304) to activate operation of example handheld device 1302 in the second mode.

In aspects, once operation in the second mode has been activated, example handheld device 1302 can switch directional input processing from a joystick data stream 1508 to an IMU data stream 1510. For example, as stated, while handheld device 1302 is operating in the first mode or prior to activation of the second mode, first motion data generated by analog joystick 1308 can be provided through joystick data stream 1508 for downstream processing and control of digital character 1406 or another element included in example game 1404. After activation of the second mode, however, example handheld device 1302 can reduce, suspend, or replace reliance on joystick data stream 1508 and can begin using IMU data stream 1510, in place of joystick data stream 1508, to provide motion-based directional input derived from movement of handheld device 1302.

In some aspects, joystick data stream 1508 can correspond to an input-processing path through which first motion data generated by analog joystick 1308 is received, processed, and provided for downstream directional control operations. For example, as stated, joystick data stream 1508 can correspond to or include coordinate data, such as x-axis data and y-axis data, generated in response to physical movement of analog joystick 1308, such that this data can be used to control movement of digital character 1406 or another element included in example game 1404.

In aspects, reducing reliance on joystick data stream 1508 can include using first motion data from analog joystick 1308 to a lesser extent while supplementing directional control with motion information derived from IMU data stream 1510. Suspending reliance on joystick data stream 1508 can include temporarily ceasing use of first motion data from analog joystick 1308 for directional control. Replacing reliance on joystick data stream 1508 can include using IMU data stream 1510, in place of joystick data stream 1508, as the source of directional input such that motion of handheld device 1302 is used to generate directional control data corresponding to the data format otherwise associated with analog joystick 1308.

In aspects, IMU data stream 1510 can receive motion information generated by IMU 1318 and can process the motion information to determine tilt, orientation, acceleration, rotation, or other movement of handheld device 1302. Handheld device 1302 can then use the motion information obtained through IMU data stream 1510 to generate synthesized coordinate data corresponding to the data format of analog joystick 1308, such as coordinate data including an x-value and a y-value. In this manner, switching from joystick data stream 1508 to IMU data stream 1510 can preserve directional control functionality even when analog joystick 1308 is degraded, unreliable, or otherwise unsuitable as a source of directional input.

In some aspects, IMU data stream 1510 can correspond to an input-processing path through which motion information generated by IMU 1318 is received, processed, and provided for downstream directional control operations. For example, IMU data stream 1510 can receive sensor signals corresponding to tilt, movement, orientation, acceleration, rotation, or another motion-related characteristic of handheld device 1302 and can provide information derived from those signals for use in controlling digital character 1406 or another element included in example game 1404. In some aspects, IMU data stream 1510 can be used after activation of the second mode to provide motion-based directional input in place of, or in supplementation to, directional input otherwise obtained from analog joystick 1308 through joystick data stream 1508.

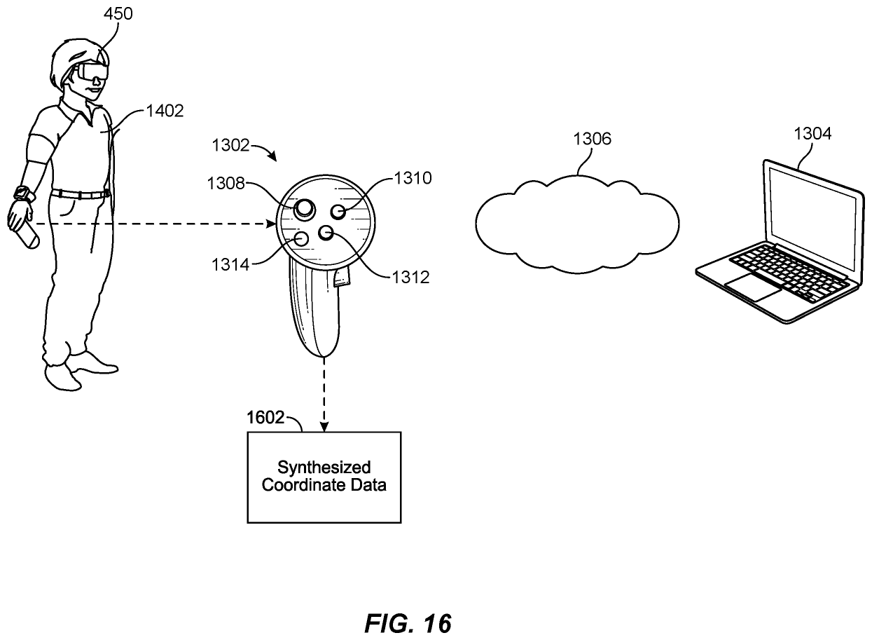

FIG. 16 illustrates the generation of the synthesized coordinate data by the corrective input data generation system of the present disclosure, according to some aspects described and illustrated herein. Specifically, FIG. 16 illustrates example handheld device 1302 operating in conjunction with example computing device 1304 to process, analyze, and synthesize raw data obtained from example IMU 1318, e.g., after operation of handheld device 1302 has been activated in the second mode, to generate synthesized coordinate data 1602. In such aspects, a processor or other computing circuitry of example handheld device 1302 can receive second motion data from IMU 1318, e.g., as a result of movement of example handheld device 1302. Such movement can include movement of the example handheld device 1302 in a left direction, a right direction, a forward direction, or a backward direction. Further, second motion data can correspond or be represented in a second data format, which is different from the first data format associated with data obtained by sensors of analog joystick 1308.

For example, IMU 1318 can include one or more accelerometers that detect and generate raw acceleration data samples along multiple axes, such as an x-axis acceleration value, a y-axis acceleration value, and a z-axis acceleration value, and one or more gyroscopes that detect and generate raw angular-velocity samples corresponding to rotational movement of example handheld device 1302, e.g., roll-rate data, pitch-rate data, and, in some aspects, yaw-rate data. In some aspects, the raw accelerometer data can be expressed as a stream of multi-axis acceleration values, for example a three-value tuple such as αₓ, α_{y}, and α_{z} in units of gravity or meters per second squared, and the raw gyroscope data can be expressed as a stream of multi-axis angular-velocity values, for example a three-value tuple such as ωᵣₒₗₗ, ω_{pitch}, and ω_{yaw} in degrees per second or radians per second.

In some aspects, these raw sensor values can be timestamped or otherwise associated with a sampling interval, such as a time step Δt, and can be received as successive samples in the second data format. Because the second data format corresponds to motion-sensor measurements rather than joystick-position coordinates, the second motion data can be processed before serving as, e.g., a replacement for the coordinate data otherwise obtained from analog joystick 1308 for the purposes of controlling movement of, e.g., digital character 1406 in example game 1404. Having obtained the raw data from, e.g., an accelerometer and a gyroscope of example IMU 1318, example handheld device 1302, operating in conjunction with example computing device 1304, may generate synthesized coordinate data 1602 that conforms to or is in the first data format, namely the data format of data obtained by sensors of analog joystick 1308.

In aspects, the first data format can correspond to an x-y coordinate pair representative of an instantaneous joystick position, whereas the second data format can correspond to accelerometer and gyroscope measurements representative of movement, orientation, tilt, acceleration, or rotation of handheld device 1302. In one illustrative example, example handheld device 1302 can receive accelerometer samples of, e.g., αₓ=0.10 g, α_{y}=0.42 g, and α_{z}=0.90 g, gyroscope samples of, e.g., ωᵣₒₗₗ=18 degrees per second and ω_{pitch}=36 degrees per second, and a sampling interval of, e.g., Δt=0.20 seconds, where a prior orientation estimate corresponds to roll that corresponds to 1 degree and pitch that also corresponds to 1 degree.

Example handheld device 1302, operating in conjunction with example computing device 1304, can process the gyroscope samples to determine a gyroscope-based orientation estimate. Example handheld device 1302 can further process the accelerometer samples to determine an accelerometer-based tilt estimate. In some aspects, example handheld device 1302 can fuse these values and thereafter constrain or clip the pitch estimate to a maximum usable control tilt, e.g., 10 degrees. In this manner, example handheld device 1302 can convert raw multi-axis IMU samples obtained from an accelerometer and a gyroscope into processed motion components usable for generation of synthesized coordinate data corresponding to the first data format specific to analog joystick 1308.

In some aspects, generating the synthesized coordinate data from the second motion data can include applying a plurality of adjustment parameters to a first motion component of the second motion data and a second motion component of the second motion data to generate an x-coordinate component and a y-coordinate component specific to the synthesized coordinate data. For example, the first motion component can represent a first value specific to a tilt motion of handheld device 1302 in one of a left direction or a right direction, such as a fused roll value, and the second motion component can represent a second value specific to an additional tilt motion of handheld device 1302 in one of a forward direction or a backward direction, such as a fused pitch value. In some aspects, the plurality of adjustment parameters can include at least one threshold value and at least one scaling value. By way of example, example handheld device 1302, operating in conjunction with example computing device 1304, can compare the fused roll value and the fused pitch value to a threshold tilt of 2 degrees to determine whether the first motion component and the second motion component satisfy the threshold value.

Responsive to determining that a given motion component satisfies the threshold value, example handheld device 1302, operating in conjunction with example computing device 1304, can apply a scaling value to that motion component to map the motion component into the coordinate space or frame associated with analog joystick 1308. For example, example handheld device 1302 can apply a scaling value corresponding to, e.g., 8-degree usable range beyond the threshold. In some aspects, a motion component that does not satisfy the threshold value can be suppressed, clipped, or mapped to a neutral coordinate value, whereas a motion component that satisfies the threshold value can be scaled, normalized, bounded, or otherwise transformed to generate the x-coordinate component and the y-coordinate component of the synthesized coordinate data.

In some aspects, the resulting synthesized coordinate data can correspond to the same first data format (coordinate values based format) used for first motion data from analog joystick 1308 and, as a result, can be processed by downstream systems as though the data had been generated by analog joystick 1308. For example, example handheld device 1302, operating in conjunction with example computing device 1304, can generate a synthesized coordinate pair, where the x-coordinate component represents left-right movement or control and the y-coordinate component represents forward-backward movement or control in the same coordinate format as that of analog joystick 1308. In some aspects, example handheld device 1302 and example computing device 1304, operating in conjunction, can generate the synthesized coordinate data continuously from successive sets of second motion data while handheld device 1302 remains in the second mode, thereby producing a stream of synthesized coordinate values that replaces, supplements, or otherwise stands in for first motion data that would otherwise be obtained from analog joystick 1308. In this manner, even though IMU 1318 produces second motion data in a sensor-oriented second data format, example handheld device 1302, operating in conjunction with example computing device 1304, can transform the second motion data into synthesized coordinate data corresponding to the joystick-oriented first data format.

In some aspects, based at least in part on satisfaction of operating mode switching condition 1408 and operation of handheld device 1302 in the second mode, example handheld device 1302 can transmit the synthesized coordinate data to a device external to the processor or computing circuitry that generated the synthesized coordinate data. For example, example handheld device 1302 can transmit synthesized coordinate data 1602 through communication network 1306 to computing device 1304 for storage and downstream processing operations in connection with example game 1404.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by the computer of a handheld device operating in a first mode, first motion data from an input actuator of the handheld device, the first motion data representing a movement of the input actuator and corresponding to a first data format;
determining, by the computer, whether an operating mode switching condition is satisfied with respect to the input actuator;
activating at least in part based on satisfaction of the operating mode switching condition, by the computer, operation of the handheld device in a second mode;
receiving, by the computer, second motion data from a sensor of the handheld device, the second motion data representing a movement of the handheld device and corresponding to a second data format;
generating when the handheld device is operating in the second mode, by the computer, synthesized coordinate data from the second motion data, the synthesized coordinate data corresponding to the first data format; and
transmitting, by the computer, the synthesized coordinate data to a device that is external to the computer based at least in part on the satisfaction of the operating mode switching condition and the operation of the handheld device in the second mode.

2. The computer-implemented method of claim 1, wherein:
the handheld device is a gaming controller;
the input actuator is an analog joystick; and
the sensor is an inertial measurement unit (IMU).

3. The computer-implemented method of claim 2, wherein the first motion data includes a plurality of coordinate values, each coordinate value including a first value along an x-axis and a second value along a y-axis.

4. The computer-implemented method of claim 1, wherein the determining of whether the operating mode switching condition is satisfied comprises determining whether the input actuator satisfies a degradation parameter.

5. The computer-implemented method of claim 1, wherein the determining of whether the operating mode switching condition is satisfied comprises receiving a user selection for initiating the second mode.

6. The computer-implemented method of claim 2, wherein the activating of the operation of the handheld device in the second mode comprises:
determining by the computer, using a contact sensor positioned on the input actuator, that a user contacted the input actuator;
determining by the computer, using the inertial measurement unit (IMU) of the handheld device, a tilt motion of the handheld device; and
implementing the activation of the handheld device in the second mode.

7. The computer-implemented method of claim 1, wherein the generating of the synthesized coordinate data from the second motion data comprises:
applying a plurality of adjustment parameters to a first motion component of the second motion data and a second motion component of the second motion data to generate an x-coordinate component and a y-coordinate component specific to the synthesized coordinate data.

8. The computer-implemented method of claim 7, wherein the plurality of adjustment parameters comprise at least one threshold value and at least one scaling value.

9. The computer-implemented method of claim 8, wherein the applying of the plurality of adjustment parameters comprises:
determining whether the first motion component of the second motion data and the second motion component of the second motion data satisfy the at least one threshold value; and
applying, responsive to the determining, the at least one scaling value to each of the first motion component and the second motion component.

10. The computer-implemented method of claim 9, wherein:
the first motion component represents a first value specific to a tilt motion of the handheld device in one of a left direction or a right direction; and
the second motion component represents a second value specific to an additional tilt motion of the handheld device in one of a forward direction or a backward direction.

11. A system comprising:
at least one physical processor of a handheld device;
physical memory of the handheld device comprising computer-executable instructions that, when executed by the physical processor, cause the physical processor to:
receive first motion data from an input actuator of the handheld device, the first motion data representing a movement of the input actuator and corresponding to a first data format;
determine whether an operating mode switching condition is satisfied with respect to the input actuator;
activate, at least in part based on satisfaction of the operating mode switching condition, operation of the handheld device in a second mode;
receive second motion data from a sensor of the handheld device, the second motion data representing a movement of the handheld device and corresponding to a second data format;
generate, when the handheld device is operating in the second mode, synthesized coordinate data from the second motion data, the synthesized coordinate data corresponding to the first data format; and
transmit the synthesized coordinate data to a device that is external to the at least one physical processor based at least in part on the satisfaction of the operating mode switching condition and the operation of the handheld device in the second mode.

12. The system of claim 11, wherein:
the handheld device is a gaming controller;
the input actuator is an analog joystick; and
the sensor is an inertial measurement unit (IMU).

13. The system of claim 12, wherein the first motion data includes a plurality of coordinate values, each coordinate value including a first value along an x-axis and a second value along a y-axis.

14. The system of claim 11, wherein the computer-executable instructions that, when executed by the physical processor, cause the physical processor to determine whether the operating mode switching condition is satisfied by determining whether the input actuator satisfies a degradation parameter.

15. The system of claim 11, wherein the computer-executable instructions that, when executed by the physical processor, cause the physical processor to determine whether the operating mode switching condition is satisfied by receiving a user selection for initiating the second mode.

16. The system of claim 12, wherein the computer-executable instructions that, when executed by the physical processor, cause the physical processor to activate the operation of the handheld device in the second mode by:
determining, using a contact sensor positioned on the input actuator, that a user contacted the input actuator;
determining, using the inertial measurement unit (IMU) of the handheld device, a tilt motion of the handheld device; and
implementing the activation of the handheld device in the second mode.

17. A non-transitory computer-readable medium comprising one or more computer-executable instructions that, when executed by at least one processor of a computing device of a handheld device, cause the computing device to:
receive first motion data from an input actuator of the handheld device, the first motion data representing a movement of the input actuator and corresponding to a first data format;
determine whether an operating mode switching condition is satisfied with respect to the input actuator;
activate, at least in part based on satisfaction of the operating mode switching condition, operation of the handheld device in a second mode;
receive second motion data from a sensor of the handheld device, the second motion data representing a movement of the handheld device and corresponding to a second data format;
generate, when the handheld device is operating in the second mode, synthesized coordinate data from the second motion data, the synthesized coordinate data corresponding to the first data format; and
transmit the synthesized coordinate data to a device that is external to the computer based at least in part on the satisfaction of the operating mode switching condition and the operation of the handheld device in the second mode.

18. The non-transitory computer-readable medium of claim 17, wherein the handheld device is a gaming controller.

19. The non-transitory computer-readable medium of claim 18, wherein the first motion data includes a plurality of coordinate values, each coordinate value including a first value along an x-axis and a second value along a y-axis.

20. The non-transitory computer-readable medium of claim 17, wherein:
the input actuator is an analog joystick; and
the sensor is an inertial measurement unit (IMU).
